(19) United States
(12) Patent Application Publication
(10) Pub. No.: US 2012/0231441 A1
(43) Pub. Date: Sep. 13, 2012

(54) SYSTEM AND METHOD FOR VIRTUAL CONTENT COLLABORATION

(75) Inventors: Sowmya Parthasarathy, Kendall Park, NJ (US); Rajaraman Krishnan, Chennai (IN)

(73) Assignee: COAXIS SERVICES INC., Kendall Park, NJ (US)

(21) Appl. No.: 13/393,572

(22) PCT Filed: Sep. 2, 2010
(86) PCT No.: PCT/US10/47650

§ 371 Date: May 30, 2012

Related U.S. Application Data
(60) Provisional application No. 61/275,853, filed on Sep. 3, 2009.

(51) Int. Cl. G09B 7/00; G06F 15/16

(52) U.S. Cl. 434/362; 709/205

(57) ABSTRACT

An information sharing system includes a database, an application module, a supervisor module, and a subordinate module. The database stores user data associated with a supervisor and a subordinate, and static data to be shared by them. The static data is associated with a topic for training. The application module is configured to communicate with the database. The supervisor module is configured to enable the supervisor to communicate with the application module and the subordinate module. The subordinate module is configured to enable the subordinate to communicate with the supervisor, enable the subordinate to communicate with the application module via handwritten input, audio input, video input, and image input, provide an electronic prompt to the subordinate that is triggered by the static data, and receive an electronic input comprising at least one of handwritten input, audio input, video input, and image input from the subordinate responsive to the prompt.

### CROSS-REFERENCE TO RELATED APPLICATIONS

This application claims priority under 35 U.S.C. §119(e) from copending Provisional Application Ser. No. 61/275,853, filed Sep. 3, 2009, the entirety of which is hereby incorporated herein by reference.

### BACKGROUND

Recent advances in telecommunications and networking are enabling new forms of communication and information sharing between people who are physically remote from one another but in virtual proximity. Electronic modes of communication are replacing print documents in a variety of contexts, especially with increases in computing power and hardware capabilities. The Internet is enabling a variety of tasks to be performed electronically with additional functionality previously not available.

One context for information sharing that has the potential to transform society is the emergence of the virtual classroom. Whereas teachers and students have been collocated in traditional physical classrooms, virtual classrooms enabled by the Internet have the potential to link teachers and students from around the world. A variety of challenges accompany such a virtual classroom. Virtual classrooms in known implementations are constrained in terms of the interactions they support between classroom participants, e.g., in terms of input modalities (typically only typed text or clicked multiple choice questions) and collaboration options (typically leaving students to fend for themselves without help from teachers or other students, or relying on traditional out-of-channel communications such as emails to the teacher). Such constraints have heretofore limited the practicality, efficiency, efficacy, and prevalence of virtual classrooms.

Electronic collaboration tools have been previously developed outside of the virtual classroom context as well. Such collaboration tools have typically been limited in terms of the types of input supported between participants. Furthermore, such tools have typically enabled collaboration that is relatively devoid, of structure, e.g., modeled after a blank sheet of paper upon which participants may add content rather than upon something richer and more useful. As a result, known collaboration tools have typically been deficient in terms of providing mechanisms for retaining the end product of collaboration beyond the end of an individual collaborative session e.g., for downstream processing. With the myriad operational and processing flows that are found in numerous areas of modern life, increasing the capabilities of virtual collaborative tools beyond those currently available has the potential to transform the way people interact with one another.

Electronic content delivery tools have suffered from similar deficiencies. For example, most content delivery tools are based on the concept of pushing flat (unstructured) information to consumers of content. Such content delivery models, though useful in their own way, are limited in terms of the degree of interactivity they enable and the amount of future processing they support.

### SUMMARY

In some embodiments, an information sharing system includes a database, an application module, and supervisor and subordinate modules. The database may store user data associated with a supervisor and a subordinate, and static data to be shared by them. The static data may be associated with a topic for training. The application module may be configured to communicate with the database. The supervisor module may be configured to enable the supervisor to communicate with the application module and the subordinate module. The subordinate module may be configured to enable the subordinate to communicate with the supervisor, enable the subordinate to communicate with the application module via handwritten input, audio input, video input, and image input, provide an electronic prompt to the subordinate that is triggered by the static data, and receive an electronic input comprising at least one of handwritten input, audio input, video input, and image input from the subordinate responsive to the prompt.

In some embodiments, a collaboration system includes a first user module, a second user module, and a sharing module. The first user module may be configured to display a virtual whiteboard comprising multiple layers of content to a first user among a plurality of users. Each layer may be associated with at least one of the plural users. The first user may be able to modify content only in said layer associated with said first user. The second user module may be configured to display the virtual whiteboard to a second user among the plurality of users. The sharing module may be configured to connect the first and second user modules over a network for real-time collaboration between the first and second users, responsive to a request by one of the first and second users, via the virtual whiteboard. The virtual whiteboard may be at least initially oriented around a contextual topic determined by the first or second user that provides a subject for the collaboration. For example, the contextual topic may be a question or a worksheet in a virtual classroom testing framework.

In some embodiments, electronic input is received from a first user. The electronic input may be stored at a first layer of information. The first layer of information may be provided to a second user. The second user may be prevented from modifying information at the first layer. Electronic input may be received from the second user. The second user's input may be stored at a second layer of information, which may overlie the first layer. The second layer may be provided to the first user. The first user may be prevented from modifying information at the second layer. The inputs from the first user and the second user may each be selected from the group consisting of an electronic document, an image, an electronic handwritten annotation, a typed annotation, an audio annotation, a video annotation, and a link to a web page.

In some embodiments, a parametric test question including multiple parameters is created. Valid values may be assigned to at least one of the parameters. One of the valid values for at least one of the parameters may be instantiated. An instantiated question including the instantiated value may be stored in a computer database. A worksheet including the instantiated question may be rendered in multiple forms. The rendered worksheet may be presented in one of the forms to a student in a virtual classroom environment.

In a computer implemented method of operating a virtual classroom, an electronic communication may be transmitted to a student. The electronic question may contain a question based on (associated with) a curriculum plan. An electronic input from the student responsive to the question may be transmitted to a teacher. The electronic input may include an answer to the question and intermediate work related to the answer. The electronic input may have an input modality selected from the group consisting of handwritten input, audio input, and video input. The teacher may evaluate the electronic input to assign a score to the student based on at least the intermediate work. The score may also be based on the answer.

In a method of processing static electronic content to support interactive learning, an electronic book comprising static questions and answers is provided. The questions and answers in the electronic book may be static in the sense that they do not provide interactivity and may only be read. An indication of a first subset of the book corresponding to a worksheet to be provided to a student may be received. An indication of a second subset of the book corresponding to a question in the worksheet may be received. The indications of the first and second subsets may be associated with a virtual interactive testing infrastructure separate from the electronic book. The virtual interactive testing infrastructure may include components of an information sharing system as in some embodiments described above. The worksheet and question may be presented to a student via the virtual interactive testing infrastructure along with presentation of the electronic book.

In some embodiments, electronic input from a user is received over a first time interval. The electronic input may be handwritten input or typed input. Audio input may be received from the user during a second time interval that overlaps the first time interval. The electronic input and audio input may be played back to the user over a third time interval.

In some embodiments, electronic handwritten input comprising a plurality of scribbles is received from a user. The scribbles may be automatically clustered into scribble clusters. A user selection (indication) of a point in the input area in which the scribbles are inputted may be received. A scribble cluster nearest to the point may be identified. Scribbles may be played back beginning with the scribble(s) in the identified scribble cluster.

### BRIEF DESCRIPTION OF THE DRAWINGS

The following will be apparent from elements of the figures, which are provided for illustrative purposes and are not necessarily to scale.

FIG. 1 is a block diagram of a system architecture in accordance with sonic embodiments.

FIG. 2 is a block diagram showing the internal components of a subordinate module 140 in accordance with some embodiments.

FIG. 3 is a flow diagram of a login process in accordance with some embodiments.

FIG. 4 is a sample depiction of a display showing a customized sample of worksheet information displayed for a student.

FIG. 5 is a sample depiction of how a question is displayed to a student in accordance with some embodiments.

FIG. 6 is a sample depiction of a display of a reference page in accordance with some embodiments.

FIG. 7 is a sample depiction of a display showing a text area in accordance with some embodiments.

FIG. 8 is a sample depiction of a display showing a multiple choice answers area in accordance with some embodiments.

FIG. 9 is a sample depiction of a display for a teacher in stealth mode in accordance with some embodiments.

FIG. 10 is a depiction of a sample display of a student's grade and performance on a worksheet or assignment.

FIG. 11 is a depiction of a display showing a teacher's markup (correction) of a student's response to a question.

FIG. 12 is a depiction of a sample display of a class list.

FIG. 13 is a depiction of a sample display of a class list showing status and scribble activity of individual students.

FIG. 14 is a depiction of a sample display shown to a teacher when grading a worksheet.

FIG. 15 is a depiction of a sample display showing assigned worksheets and worksheets waiting to be graded.

FIG. 16 is a depiction of a sample view of a graph of time taken by a student for various problems.

FIG. 17 is a depiction of a shared virtual whiteboard in accordance with some embodiments.

FIG. 18 is a depiction of a sample scribble instant messaging (IM) display.

FIG. 19 is a depiction of a sample display for adding parties to a collaboration session.

FIG. 20 is a depiction of a sample display for inviting a participant to join an audio call.

FIG. 21 is a depiction of a sample display for inviting a participant to join a video call.

FIG. 22 is a diagram illustrating layers in accordance with some embodiments.

FIG. 23 is a diagram showing how layers of information may be transmitted between users in accordance with some embodiments.

FIG. 24 is a flow diagram of a process involving layered information in accordance with some embodiments.

FIG. 25 is a diagram showing collaboration between multiple users at a single layer of information in accordance with some embodiments.

FIG. 26 is a flow diagram of a process used by the application module for selecting a teacher for a sharing session.

FIG. 27 is a flow diagram of a process involving processing layered information in accordance with some embodiments.

FIG. 28 is a flow diagram of a process involving instantiating and rendering information associated with a worksheet in accordance with some embodiments.

FIG. 29 is a flow diagram of a process involving testing a student in accordance with some embodiments.

FIG. 30 is a diagram showing how different elements associated with worksheet generation are related.

FIG. 31 is a depiction of a sample display for a notetaking application in accordance with some embodiments.

FIG. 32 is a depiction of a sample display of scribble mode for the notetaking application.

FIG. 33 is a depiction of a sample display for sharing a notebook.

FIG. 34 is a depiction of a sample display of text mode for the notetaking application.

FIG. 35 is a depiction of a sample display of view mode for the notetaking application.

FIG. 36 is a depiction of a sample display of a markup view for the notetaking application.

FIG. 37 is a depiction of a sample display of play mode for the notetaking application.

FIG. 38 is a depiction of a sample display of search results when searching for shared notebooks with the notetaking application.

FIGS. 39A and 39B are depictions of a sample display for marking source content in an electronic book corresponding to a worksheet in a virtual classroom environment.

FIG. 40 is a flow diagram of a process involving active digitization of external source content in accordance with some embodiments.

FIG. 41 is a flow diagram of a process involving note taking in accordance with some embodiments.

FIG. 42 is a flow diagram of a process involving playing back handwritten electronic input in accordance with some embodiments.

FIG. 43 is a block diagram of a computer architecture in accordance with some embodiments.

FIG. 44 is a diagram of layers involving notetaking in accordance with some embodiments.

FIG. 45 is a depiction of a sample display of a background view mode in accordance with some embodiments

### DETAILED DESCRIPTION

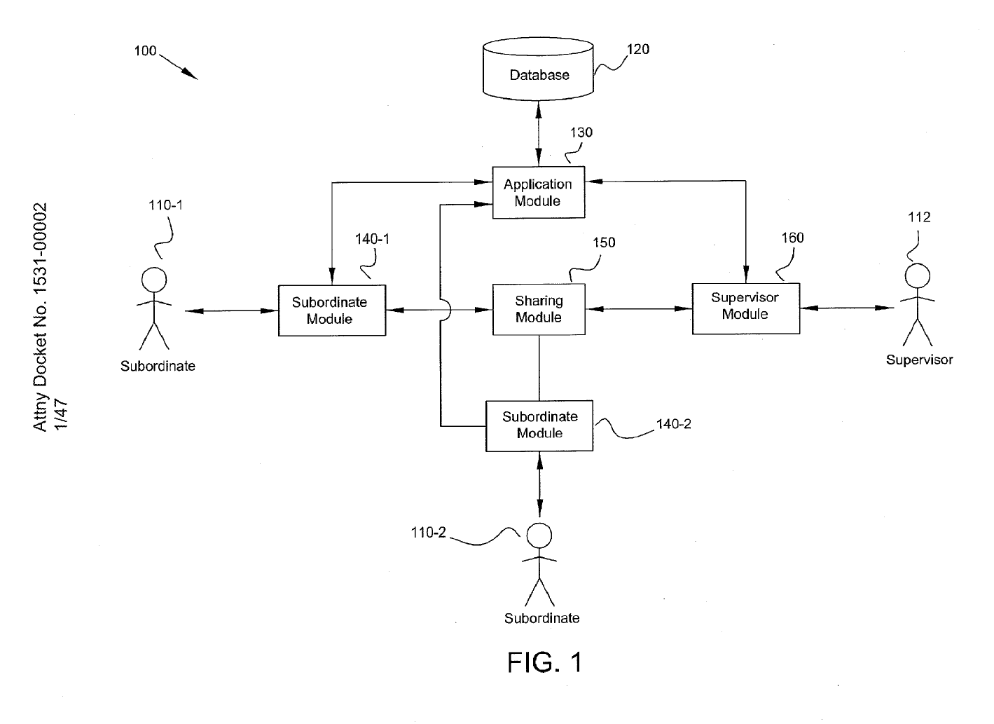

FIG. 1 is a block diagram of a system architecture in accordance with some embodiments. An information sharing system 100 includes components promoting information sharing, virtual collaboration, and various benefits resulting from networked interaction between subordinates and supervisors. As used herein, “supervisor” refers to a provider of information or training, and “subordinate” usually refers to a recipient or beneficiary of such information or training. Subordinates may also interact with one another in a peer-to-peer mode, with one subordinate sharing information with another subordinate, and supervisors may also interact with one another in a peer-to-peer mode. The terms “supervisor” and “subordinate” are relative and related to an information sharing context rather than to strict hierarchical roles in society. For example, an entry level worker may be a “supervisor” and the president of his/her company may be a “subordinate” in sonic scenarios, e.g., with the entry-level worker training the president on new electronic gadgets.

Embodiments in a variety of contexts are contemplated, as information sharing and training are fundamental human activities that permeate many areas of society. For example, the familiar academic context of a teacher and a student situates the teacher as a supervisor and the student as a subordinate. For ease of understanding and familiarity, the teacher/student example is discussed at length below, but it should be understood that such an example is merely one example contemplated by the present disclosure.

In FIG. 1, system 100 includes a computer database 120, an application module 130, a sharing module (communication module) 150, one or more subordinate modules 140-1, 140-2 (generally 140) configured to enable communications between corresponding subordinates 110-1, 110-2 (generally 110) and other parties interacting with the system 110, and one or more supervisor modules 160 configured to enable communications between corresponding supervisors (e.g., supervisor 112) and other parties. Although FIG. 1 shows one supervisor 112 for visual clarity, system 100 may include more than one supervisor. Supervisors may interact with other supervisors in various embodiments. In the discussion below, it is understood that multiple subordinates and subordinate modules and multiple supervisor modules and supervisors may be present, and reference to any of these terms in the singular (e.g., “the subordinate module”) is only for convenience.

The database 120 stores user data associated with the supervisor 112 and the subordinates 110. In the following discussion, a virtual classroom environment, in which students and/or teachers interact with one another remotely, is used as an example to explain various non-limiting aspects of embodiments. For example, the user data stored in the database 120 may include demographic information about students, e.g., gender or age, or descriptive information about students relative to a classroom setting, e.g., grade level or classes taken. Similarly, user data corresponding to a teacher may include information about the courses being taught by the teacher, class lists, and other information pertinent to a teacher's role in an educational system. The database 120 also stores static data to be shared by the supervisor and the subordinate. The static data is associated with a topic for training. For example, static data may be content related to a curriculum plan implemented being taught by a teacher to a student, e.g., test questions or problems, instructional materials, reference materials, curriculum aids, etc.

Each subordinate module 140-1, 140-2 (generally 140) includes a platform-independent user interface (UI) based application that acts as a primary tool for subordinates 110 in interacting with a supervisor 112 and/or another subordinate 110. In the educational context, the subordinate module 140 enables the subordinate (student) 110 to log into the application module 130 to access the educational content and other data stored at the application module 130, as well as interact with the other subordinates 110 (students) and supervisors (teachers) 112 using the sharing module 150. The subordinate module 140 provides an electronic prompt to the student 110 that is triggered by the static data, e.g., by test questions stored in the database 120. For example, the static data may include a worksheet containing multiple questions designed to test the student's knowledge, and a particular question may be triggered for presentation to the student based on various factors, such as an ordering of the questions in the worksheet, past performance of the student, a student selection of a particular question, a predetermined plan to provide certain curricular content to students at certain times, etc.

The electronic prompt may be any type of prompt that requests the student 110 to provide a responsive input (e.g., an answer to a test question or problem). The subordinate modules and supervisor modules may include software applications running on computers operated by subordinates and supervisors, respectively. The subordinate modules 140 and supervisor modules 160 may be connected directly to the application module 130 and sharing module 150, or they may be connected via intermediate nodes, e.g., in a “cloud” setting as described further below. Thus, the architecture of system 100 is highly scalable and enables network-independence, as disparate nodes may be connected in a variety of ways utilizing any type of electronic network.

The supervisor module 160 includes a platform-independent user interface (UI) based application that acts as a primary tool for a subordinate 112. In a virtual classroom environment, the supervisor module 160 enables the teacher 112 to log into the application module 130 to access the educational content and other data stored therein, as well as interact with the students 110 and other teachers 112 using the sharing module 150.

The application module 130 allows the supervisor module 160 and the student module 140 to access the data in the database 120. The application module may be a web server processing requests from a web client implemented by the subordinate and supervisor modules.

The sharing module 150 allows real-time collaboration between multiple participants by relaying a request for collaboration from one participant to one or more other participants in the collaboration. The sharing module 150 is interfaced with in a similar way by the subordinate module 140 and the supervisor module 160. The sharing module 150 may be a server that provides connectivity between disparate nodes using known communication platforms. The implementation of the sharing module may be separate from (independent from) the rest of the system 100.

The database 120 is a storage component. The application module (e.g., application server) 130 provides access to data in the database 120 for all the other modules. The database 120 uses standard techniques for using and storing data. Therefore, the discussion below only focuses on the interface provided by the application module 130 and not on the internal details of the database 120.

in the following description of various components of system 100, the subordinate module 140 is referred to as a student module, and the supervisor module 160 is referred to as a teacher module, but such description does not limit the scope of the present disclosure to academic contexts. In some embodiments, there are three threads of execution within the application module 130. A user interface (UI) thread 260 handles the user interaction. When in a sharing mode, the UI thread also directly sends messages to the sharing module 150. An Application Server interface Thread (ASIT) 230 completely handles the interaction with the application module 130. A Sharing Server Receive Thread (SSRT) 250 deals with packets received from the sharing module 150 and takes appropriate action when such data is received. All of these threads read from and write to a local data store 220. The contents and the format of the data in the local data store 220 is described further below.

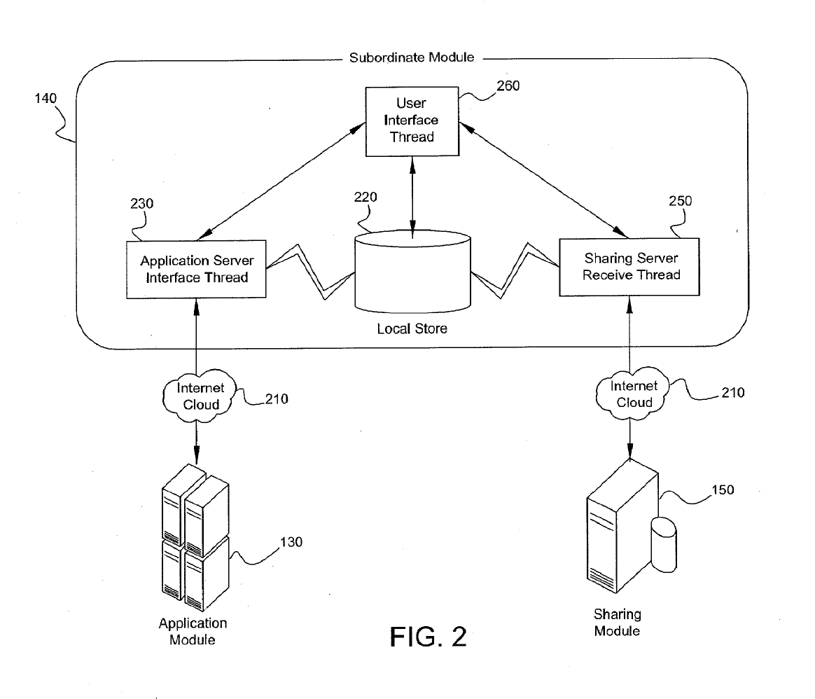

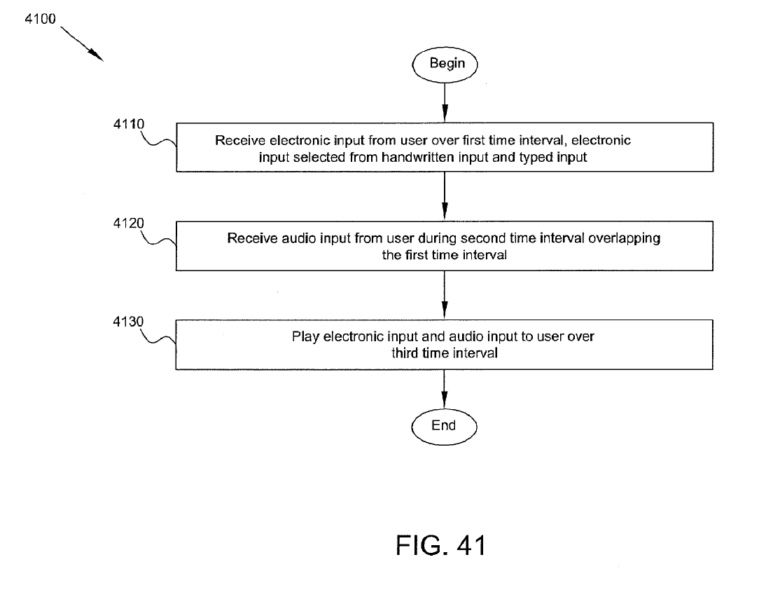

FIG. 2 is a block diagram showing the internal components of the subordinate module 140 in accordance with some embodiments. The subordinate module 140 may be implemented in Java, which is a widely supported language across most operating system platforms, or in other suitable programming languages. This module is designed to work either as a standalone client based application or as a browser based web application. Besides the description below in the context of FIG. 2, additional details regarding the subordinate module 140 (and the supervisor module 160) are provided further below in the context of FIG. 41

Asynchronous Login

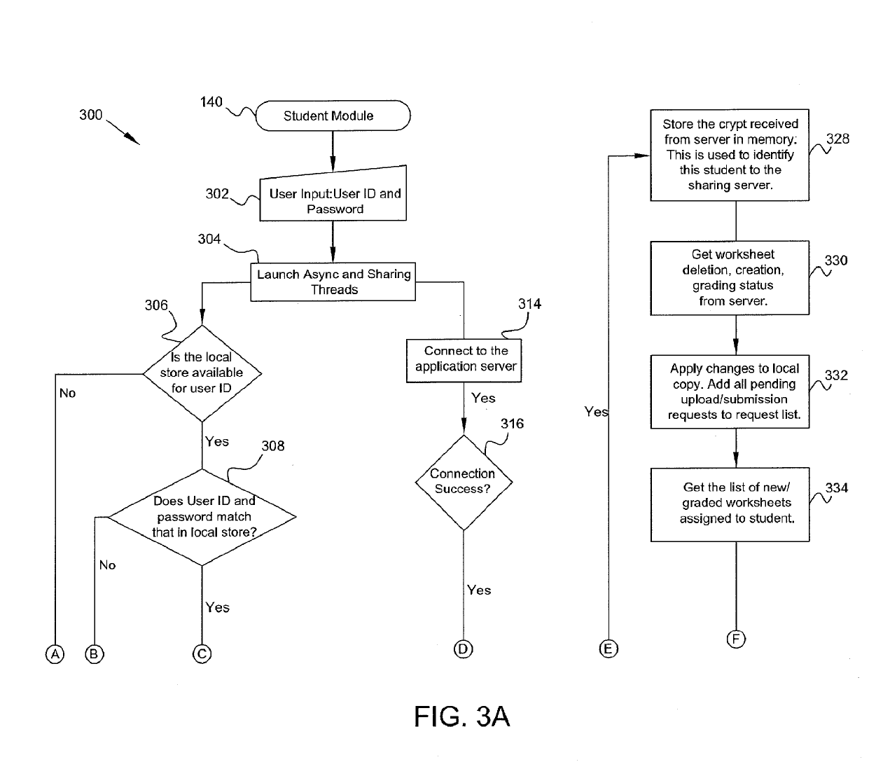

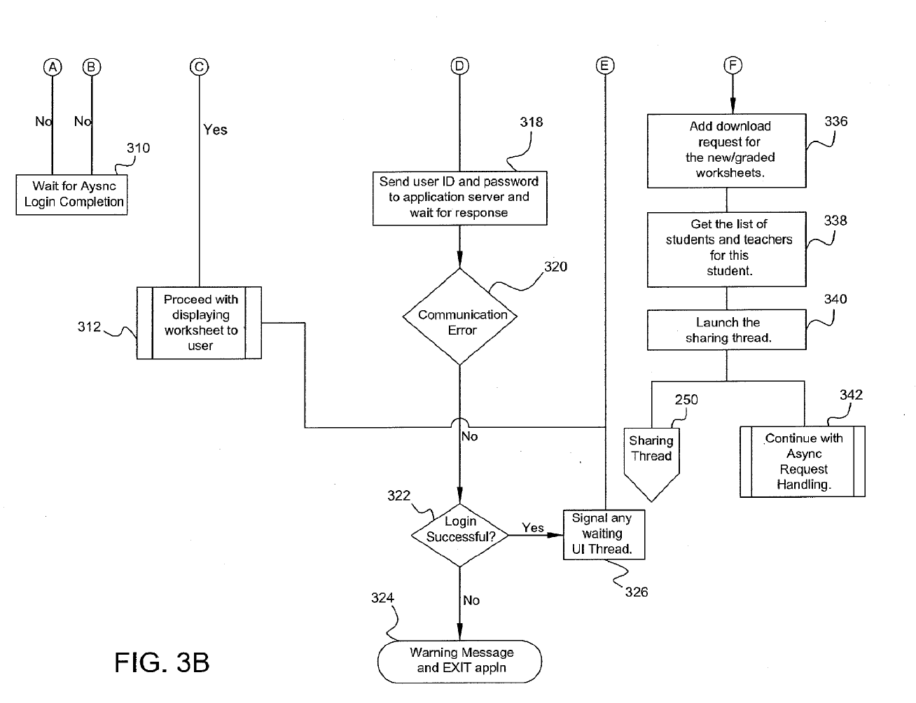

FIG. 3 is a flow diagram of a login process 300 in accordance with some embodiments. The student module 140 initially presents a login screen (302). Once the login information is obtained, the student module 140 launches the ASIT 230 and the SSRT 250 (304). The UI thread 260 checks to see if data for the login ID is already present in the local store 220 (306). If such data is present, the UI thread 260 validates the login (308) and proceeds to allow the student access to all the local data (312). If the UT thread 260 cannot validate against the local copy or if login information is not present in the local store 220, the UI thread 260 forces the user to wait (310) until the server login is completed by the ASIT 230.

This allows the user to access the functionality of the system 100 even when a network connection is not present. In some embodiments, the subordinate module 140 and supervisor module 160 are each configured to enable a corresponding user to access the static data and provide responses when the subordinate module 140 or supervisor module 160 is not in communication with the application module 130 or the sharing module 150, e.g., due to network conditions or the user going offline. Processing flow for asynchronous login is shown in FIG. 3. The student module 140 allows multiple local stores within a device. The student module 140 decides which local store to use based on the identity of the login user as determined by the USER ID of the user. This allows the same computer or device to be used by multiple users.

The login response from the application module 130 returns information to the student module 140. Based on the response from the application module 130, the ASIT 230 refreshes the information in the local store 220 including the following components.

The ASIT 230 may refresh the login ID and password of the user (student).

The ASIT 230 may refresh the list of newly assigned worksheets for the student. A worksheet includes multiple test questions for the student to respond to. The ASIT 230 optionally requests the download of these worksheets from the application module 130 and adds these worksheets to the worksheet list for the student.

The ASIT 230 may refresh the list of deleted worksheets. The ASIT 230 checks if any worksheet that has already been downloaded is deleted in the application module 130 (presumably by the teacher), in which case the local copy will also be deleted.

The ASIT 230 may refresh the list of graded worksheets. The ASIT 230 optionally requests the download of teacher feedback on each question in the worksheet and stores this in the user's local store 220.

The ASIT 230 may refresh the list of new contents the student is assigned to read. Optionally these are downloaded to the local store 220.

The ASIT 230 may refresh the list of students and teachers who are contacts for this student. This includes all the students in the courses the student is taking. The list of teachers may include the class teacher for this student, list of teachers for all the courses the student is taking, or a pool of teachers assigned by the application module 130 for this student (where the student will not know the teacher IDs and will only know the pool information).

Such information is automatically refreshed for the user by the UI thread 260. If the application module (e.g., server) login fails after the local login succeeded (e.g., because the user was disabled at the server), then the local user ID/password information is deleted and the current session is terminated.

Once the login is successful, the SSRT 250 is launched. The SSRT 250 registers the student and continues handling messages from the sharing module 150. This mechanism is in common with the teacher module 160.

ASIT Functioning

The asynchronous thread offloads all the application module 130 interactions (request/upload and response/download) away from the UI thread 260. After the login process described above, the ASIT 230 loops, waiting for a request. The request may be any upload or download request including the following: download a new worksheet; download grading details from a graded worksheet (only the correction details; teacher markups and any audio responses may have already been downloaded separately if the worksheet is already downloaded); download contents or content links (which will then be downloaded only when viewed by the student module 140); upload question responses (here again, only the answer and the student writings or scribbles need to be uploaded since the question and worksheet information is already present in the application module 130); upload audio question to the application module 130; mark the worksheet as “submitted” on the application module 130.

A request to connect to the application module 130 is received (314). If the connection is successful (316), flow continues to 318. If the ASIT 230 encounters communication errors when processing a request to connect, it will reattempt connection with the application module 130. At 318, the user ID and password are sent to the application module 130, and a response is awaited. In the absence of communication errors 320, a check is made to determine if the login is successful (322). If the login unsuccessful, a warning message is displayed and the student application running at the student module is exited (324). When a success response is received from the application module 130, any waiting 111 threads 260 are signaled (326). The ASIT 230 will remove the request and mark the appropriate element in the local store 220 as “uploaded” (for upload requests). These requests are structured to ensure the following properties or characteristics. When a request is not completed, there will always be a local copy so that the student application can continue with its functionality unhindered. Additionally, the requested operations are idempotent. If the student module 140 crashes or is restarted after the operation is performed by the application module 130 but before the local copy is updated, then when the system restarts, these operations will once again be performed on the application module 130. This mechanism guarantees that no additional problems are created. The characteristics of these requests and the ASIT 230 ensure that the student module 140 can operate effectively with sporadic network connectivity.

Worksheet List Display

Once the UI thread 260 progresses beyond the login process (local login if available or server login to application module 130), it presents the user with a list of worksheets available in some embodiments. These may also include assigned reading materials. The category of items available in this view may include a list of contents available for the student which may be marked as “new”, “partially read” or “completed,” and a list of worksheets available for the student which may be marked as “new”, “incomplete”, “submitted” or “graded.”

All this data may be downloaded locally to enable quick access even when network connectivity is not available. Alternatively, such data may be left at the application module 130, and the desired worksheets and contents may be downloaded as needed. In some embodiments, every time the user returns to the Worksheet List Display, the lists are refreshed with the latest information. The product is also customizable to either display worksheets and/or any other content available to the student. FIG. 4 is a sample depiction of a display showing a customized sample of worksheet information displayed for a student. FIG. 4 shows a tab 410 for new and incomplete worksheets/assignments, a tab 412 for submitted worksheets/assignments, and a tab 414 for graded worksheets/assignments. Assignment and worksheet information 416 is also displayed. The user (student) has the option to view or edit the selected content or worksheet. In addition, the user is unable to edit worksheets that have already been submitted or graded.

Editing/Viewing a Worksheet

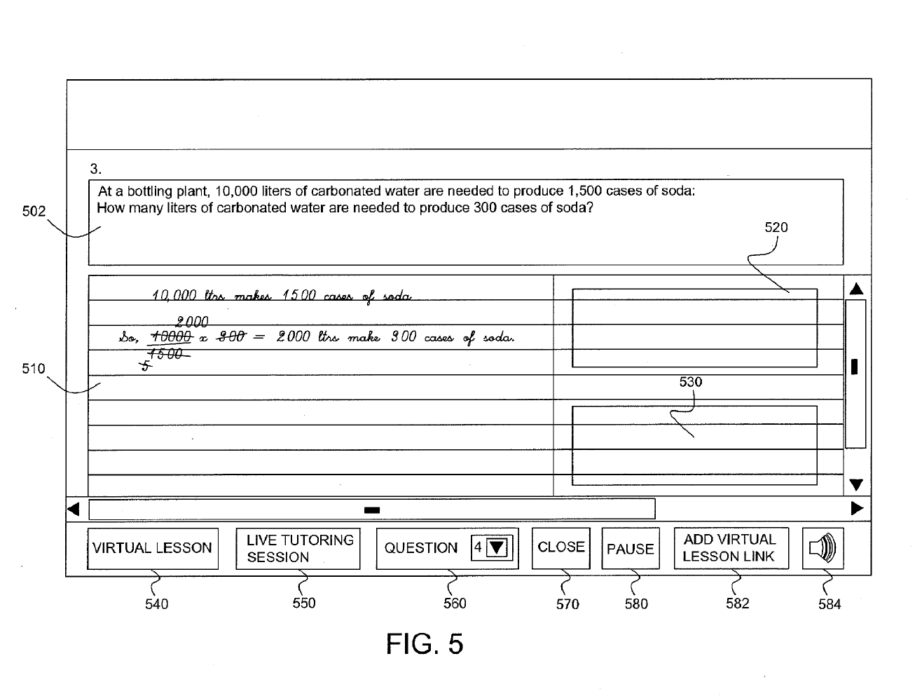

In some embodiments, a worksheet may be viewed and edited one question at a time. FIG. 5 is a sample depiction of how a question 502 is displayed on a tablet PC with some of the features described below, in some embodiments, electronic handwritten input is provided on a tablet PC or equivalent touch input device, e.g., using a stylus. As used herein, “handwritten” refers to freeform input entered electronically. The display of a question 502 to the student can be substantially customized based on the nature of the UI (e.g., web interface, local application on a tablet, local application on a non-tablet computer, or a smartphone). The intention behind the sample figure is to place this discussion within a context and not to limit the nature of the UI. The following items in Table 1 are optionally displayed to the user.

TABLE 1
Items optionally displayed to the user

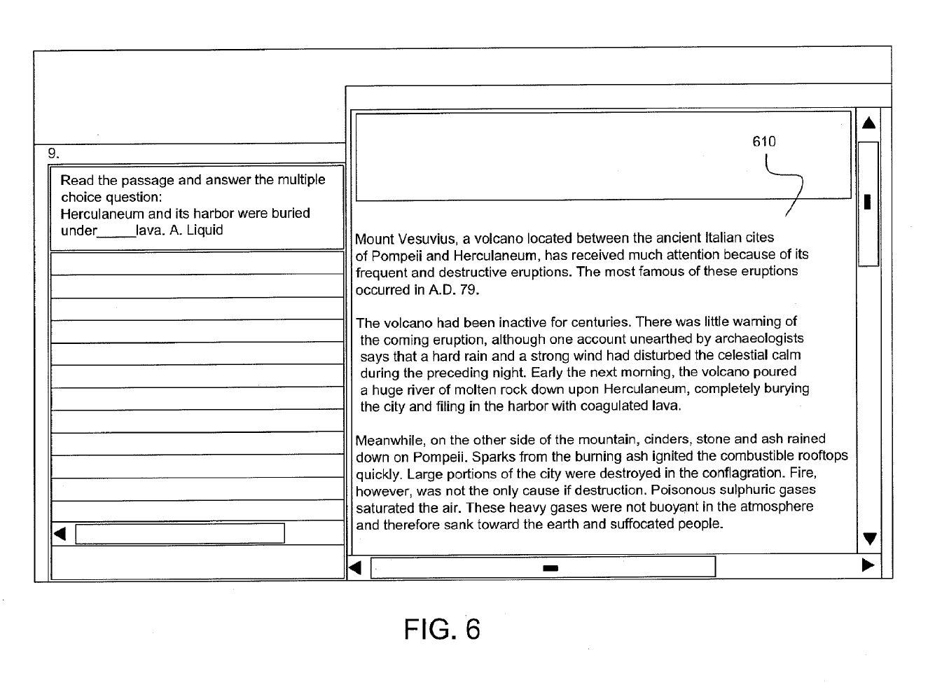

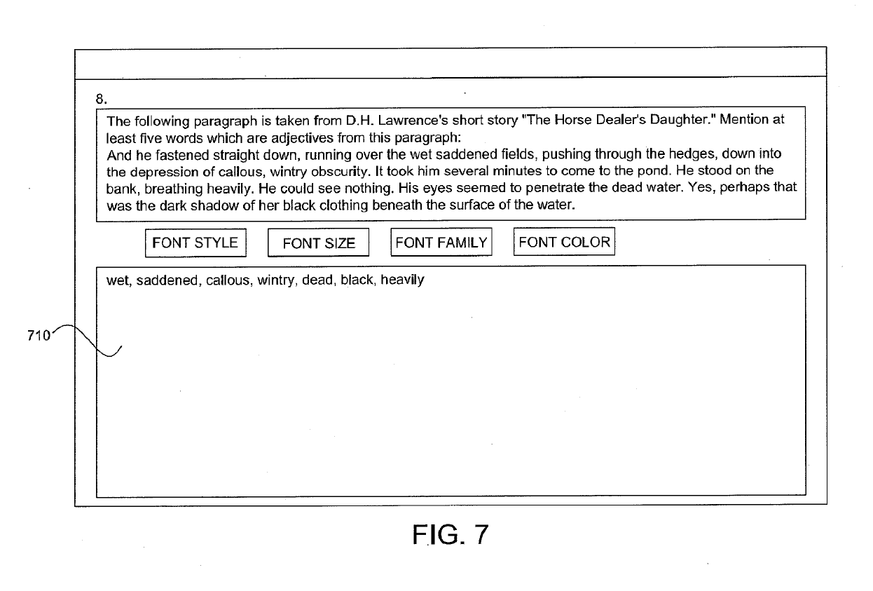

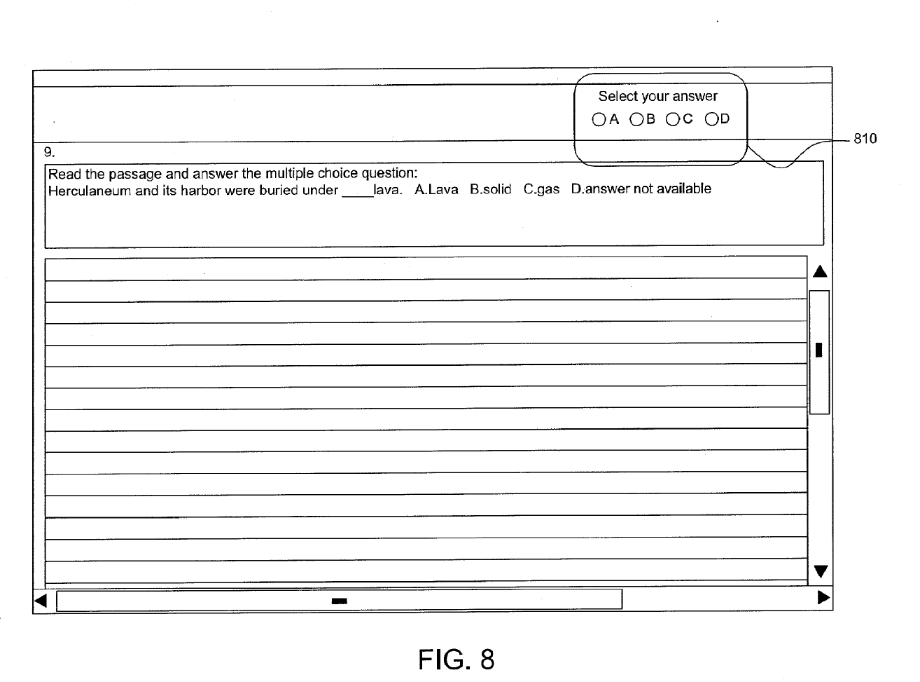

A question 502. The question (also referred to as a test question) may be a question or
problem on a homework assignment, quiz, test, etc. and refers to a task that the student
is prompted to respond to. In some embodiments, multiple questions are displayed to
the student on a single screen of a display.
A reference page for the question. Refer to FIG. 6, which is a sample depiction of a
display of a reference page 610. A reference page typically provides information that is
common to and is relevant for answering one or more questions. For instance, for a set
of questions that test reading comprehension that are based on a passage, the reference
page may comprise the passage.
A scribble (working) area 510. The user may scribble, i.e., provide freeform
handwritten electronic input.
A text (working) area. Refer to FIG. 7, which is a sample depiction of a display showing
a text (working) area. 710.
Answer scribble area 520 where the student can scribble just the answer to be digitally
recognized.
A digital answer pad 530 to enter digital answers when the reliability of the character
recognition is not sufficient.
A multiple choice answers area 810 (see FIG. 8) for students to select the correct
answer.
Portions of a question to appear in the scribble area.
Button/mechanism 540 to launch virtual lessons or tutorials.
Button/mechanism 550 to launch live tutoring session with a teacher. In some
embodiments, this button is active only if the teacher(s) is/are online. The teacher's
online status (or the online status for multiple teachers) is communicated to the student
module 140 by the sharing module 150.
Buttons, slider, pull down menu 560 or other mechanism to navigate to other questions.
A region to indicate the number of questions answered, total number of questions, time
taken so far, total time allocated for the worksheet, current question number and other
applicable and relevant features as desired by customers.
Buttons for “closing” 570 and/or “pausing” 580 a worksheet.
A button/mechanism 582 to add a virtual lesson link.
A button/mechanism 584 to submit a voice question for the teacher.

The user may perform the following representative actions from this UI as listed in Table 2.

TABLE 2
Representative actions the user may perform

If the worksheet is not yet submitted, the student is able to do all normal
editing functions on all the editable areas on the Worksheet Display
View including scribble area, scribble answer area, text working area
and others. In the scribble view this would include changing line color,
line thickness, patterns, changing font type, font size, and font color of the
text and associated text with various shapes, draw a scribble, line, various
shapes and other typical features. In the text view the user is able to insert,
delete text in chosen font, color and size and other typical formatting and
editing features. In both views the user is able to cut to or paste from the
clipboard.
Enter the answer in the answer area or select the answer for a multiple
choice question. Details are discussed in subsequent sections.
Navigate to another question.
Close or Exit the worksheet.
Launch a virtual tutoring session. Details are provided further below.
Launch a live tutoring session. Details are provided further below.
Launch a view to show the online status of all contacts (students in the
class and teachers). Details are provided further below.
Add a new virtual lesson for this question, question type or worksheet.

In addition to the actions of the UT thread as invoked by the user actions above, the platform supports the following functions listed in Table 3.

TABLE 3
Functions supported

Record timings of the user interactions. Details are provided further below.
Verify answers upon question transition. Details are provided further
below.
Verify worksheet status. When the user transitions out of the last question
in the worksheet or explicitly closes the worksheet, the system checks
if all the questions in the worksheet have been completed. Based on the
completion status of the questions, the application queries the user's
intent to continue working with the worksheet, close it without submitting
(to later work on it) or proceed to submit it. Based on the response from
the student, the application will take appropriate action to submit the
worksheet, close the worksheet or allow the student to continue working
with the worksheet.
Send all worksheet interactions created by the student to a “stealth”
watcher (e.g., a teacher.) Details are provided further below.
In the background, upload updates to answers for different questions,
audio/text messages and other communications by passing an upload
request to the ASIT 230

The subordinate module 140 tags the student's response to a problem for subsequent evaluation by the teacher. In some embodiments, the subordinate module 140 receives from the student a link (e.g., a hyperlink) to external content, i.e., content external to the static data including the problem. The external content is added to the student's response, and both are transmitted to the application module 130. In this way, students may provide external content of various types in responding to problems.

In some embodiments, the student may provide audio input to the subordinate module 140, which may facilitate learning for students who are physically challenged, for example. The subordinate module 140 transmits the student's audio input to the supervisor module 160 for outputting to the teacher, who may then provide an audio input to the supervisor module 160. The teacher's audio input is then transmitted back to the subordinate module 140 to be played back to the student. Video input instead of audio input may be provided by the teacher and/or student at various stages in the process. In some embodiments, video input includes electronic handwritten input and audio input, e.g., recorded together so that they will be played back in a synchronized fashion. In this manner, audio commentary accompanying scribbles is faithfully replayed to another party. In other embodiments, video input includes input from a video camcorder, webcam, or similar video input device.

Layering

In some embodiments, questions are displayed in a separate text area 502 and/or in the scribble area 510. In particular, questions that require answers to be written on top of them may be placed directly on of the editable scribble area 510. As an example, for a question where a student has to circle the points of inflection on a graph, the question may be displayed in the editable scribble area 510 to enable the student to make markings directly on the graph.

One of the important aspects of this is that the question image and the scribble drawn by the student are drawn in two different but overlapping layers. When the student erases his writing or clears the image, the question is not erased or cleared. The same applies for the stationery (e.g., background lines similar to ruled notebook paper) used for the scribble area 510. The application allows the student to apply a variety of stationery styles to the page. These stationery styles/markings occupy the same layer as the question itself and once again may not be erased or cleared by the student. Thus, a base content layer is provided to the student, who then applies a layer of information containing response information atop the base content layer.

This same principle is extended when the teacher grades the student's worksheet. Scribbles by the teacher on top of the student answers may occupy a separate layer. Thus, “erase” and “clear” actions by the teacher may affect only their own scribbles and have no impact on the student's scribbles, question image, or stationery imprints (i.e., on content in other layers).

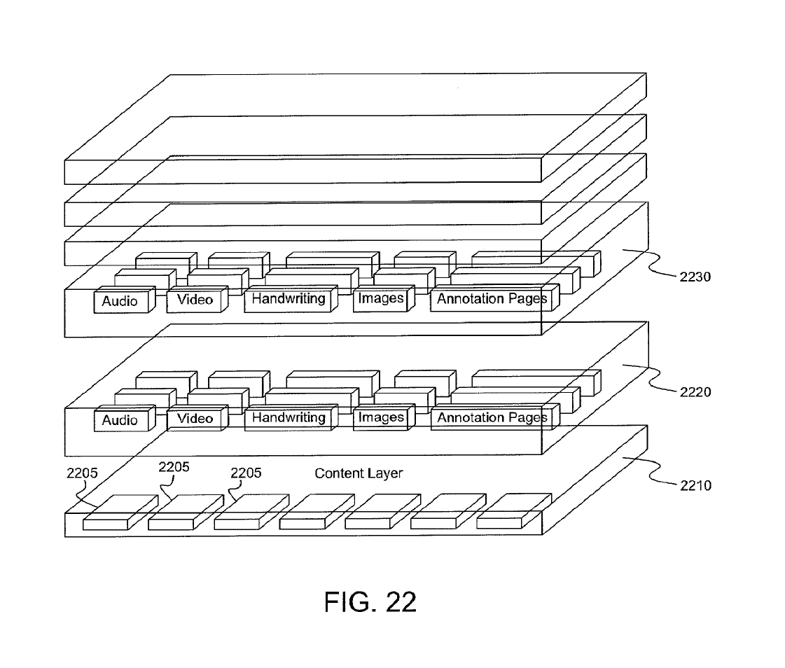

FIG. 22 is a diagram illustrating layers in accordance with some embodiments. A base layer 2210 of information includes content items 2205, which may include source content from an e-book, images, documents, and other electronic data. A layer 2220 overlies the base layer 2210. Layer 2220 may include audio, video, electronic handwriting, images, and annotation pages, as may a layer 2230 above layer 2220. Additional layers may be placed above layer 2230.

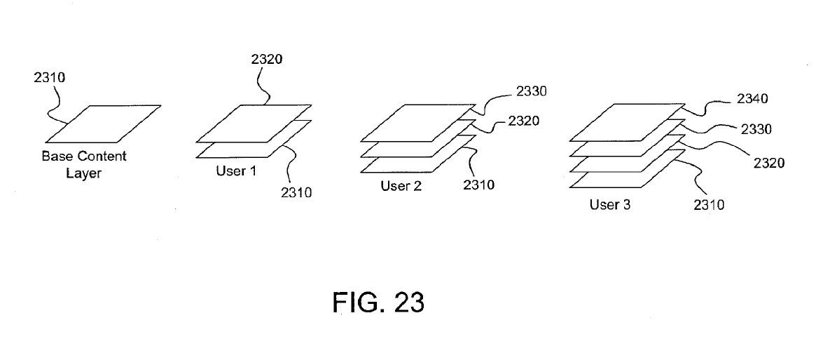

FIG. 23 is a diagram showing how layers of information may be transmitted between users in accordance with some embodiments. A base content layer 2310 is provided to a user User1, who adds a layer 2320, e.g., by uploading content or providing electronic handwritten scribbles, audio, video, or other electronic input. Layers 2310 and 2320 are passed to another user User2, who adds a layer 2330, and the resulting materials are passed onto another user User3, who adds yet another layer 2340.

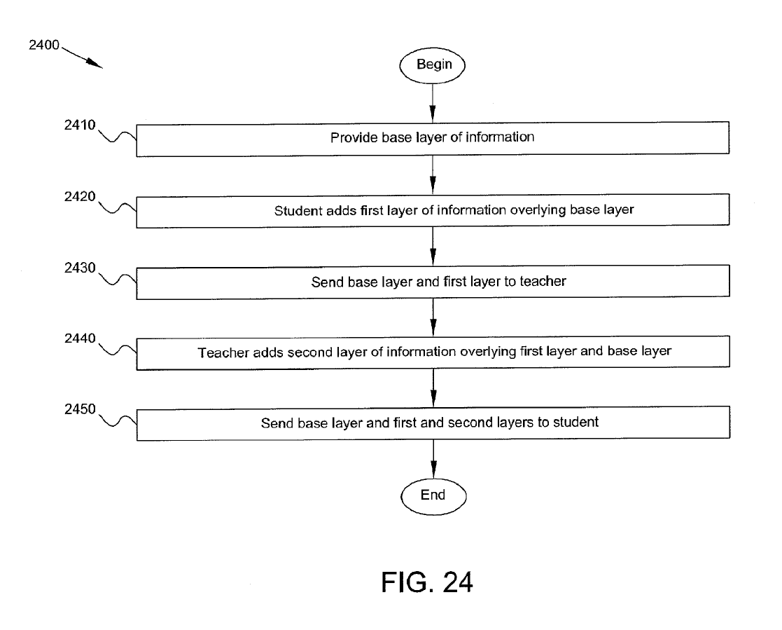

FIG. 24 is a flow diagram of a process involving layered information in accordance with some embodiments. After process 2400 begins, a first layer of information is provided at 2410. A student adds a first layer of information overlying the base layer at 2420. The base layer and first layer are sent to the a teacher at 2430. The teacher adds a second layer of information overlying the first layer and the base layer at 2440. The base layer and first and second layers are sent back to the student at 2450. The term “sent” used in this paragraph may refer to a synchronous send using the sharing module 150 or an asynchronous send accomplished by one user storing a given layer at the application module 130 and then another party downloading the given layer's information at a later point in time.

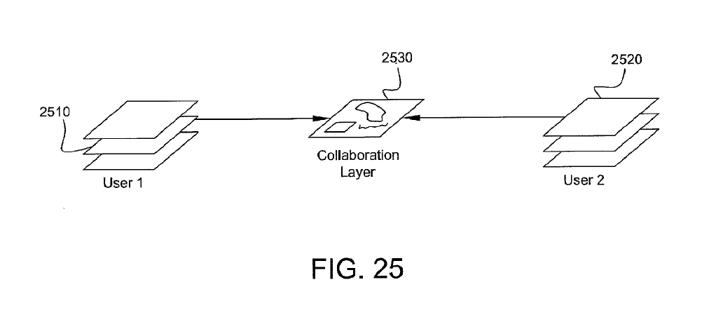

FIG. 25 is a diagram showing collaboration between multiple users at a single layer of information in accordance with some embodiments. A first user User1 and a second user User2 both have content including multiple layers of information. User1 shares one of his/her layers 2510, and user2 shares one of his/her layers 2520, to form a collaboration layer 2530 including content from both users. Thus, a single user may be associated with multiple layers, and a single layer may be associated with multiple users in some embodiments. Once the collaboration starts, both users are now viewing and working on layer 2530. The modifications to this layer made by each user are displayed to the other user(s) as well.

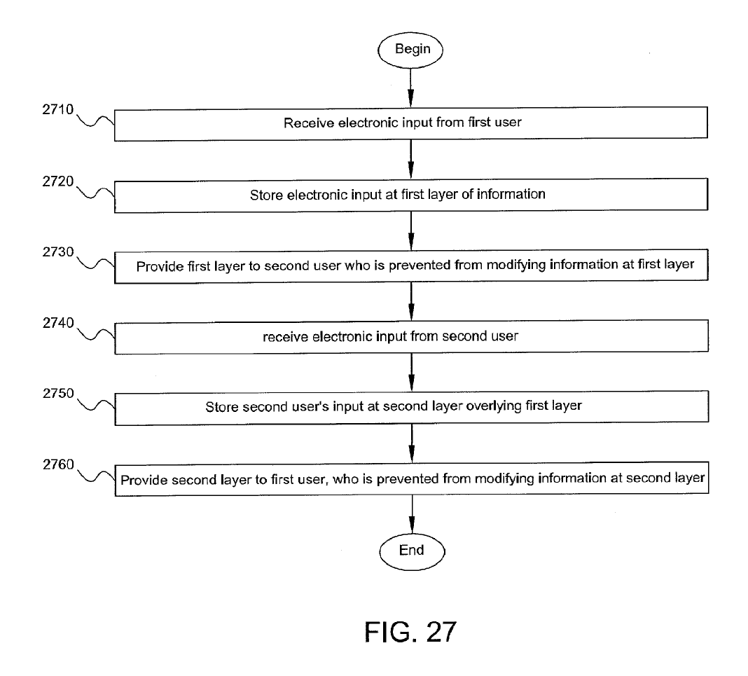

FIG. 27 is a flow diagram of a process involving processing layered information in accordance with some embodiments. After process 2700 begins, electronic input is received from a first user at 2710. The electronic input is stored at a first layer of information at 2720. The first layer of information is provided to a second user at 2730. The second user is prevented from modifying information at the first layer. Electronic input is received from the second user at 2740. The second user's input is stored at 2750 at a second layer of information. The second layer is provided to the first user at 2760. The first user is prevented from modifying information at the second layer. The inputs from the first user and the second user are each selected from the group consisting of an electronic document, an image, an electronic handwritten annotation, a typed annotation, an audio annotation, a video annotation, and a link to a web page. The first and second layers may be provided asynchronously to the second and first users, respectively, to provide sequential communication, or they may be provided synchronously to enable real-time virtual collaboration between the first and second users. In asynchronous mode, the first user's input may be stored in the application module 130, and the second user may retrieve the information of the first layer when he/she chooses.

Prior to the first user providing his/her electronic input for the first layer, he/she may be provided with a base layer of information, which may include electronic content such as content from an electronic textbook, an image, or an electronic document. The first layer overlies the base layer, and providing information at a particular layer to the first or second user includes providing information at that particular layer and at all layers below that particular layer. In a virtual classroom environment, the base layer may be a question, the first and second users may be a student and a teacher, respectively, the student's input may be a response to the question, and the teacher's input may be an analysis of that response.

Layers are not limited to handwritten (scribble) input but rather may comprise various types of information. Some embodiments provide a powerful technique for associating one or more layers with one or more users and keeping information at different layers isolated for improved collaboration.

Virtual Lessons

In some embodiments, virtual lessons are invoked by the student. This may show the list of virtual lessons available for the current question in view and may be downloaded to the system along with the worksheet. These lessons may be sent by the application module 130, e.g., in a sorted order. Such sorting may be based on the preferences of the student as described under the Application Module section further below. For example, a user may be presented with a sample suited to the content being viewed, and samples may be categorized to enable a determination of which category/categories of samples the user prefers. Such category/categories may then be shown first to the user. The list of virtual lessons can be different for each question in the worksheet. This feature enables the application to provide context sensitive lessons matched to address the question being answered. This feature also allows the content displayed to be adapted to the learning style of the student.

The user can choose the type of virtual lesson he/she wishes to see, which will then launch a separate window with the specific virtual lesson. The student application 140 may record the student's choice of virtual lesson at this time. This information will be uploaded to the application module 130 through the ASIT 230.

In addition to viewing virtual lessons, a motivated student will also be able to upload a new virtual lesson. The new virtual lesson will be associated with a worksheet, a question type, or a specific question. The question type information will be maintained by the application module 130. Once the student submits the virtual lesson, it will be uploaded to the application module 130 through the ASIT 230.

Live Tutoring and Live Sessions with Other Students

Students are associated with multiple teachers within each grade for interacting on multiple subjects. In the UI sample shown (FIG. 5), the student is associated with a single class teacher for a specific subject. The live tutoring session button 550 may be enabled if the teacher is online and disabled if the teacher is not online, in this case, clicking the button will connect the student to the teacher through the sharing module 150.

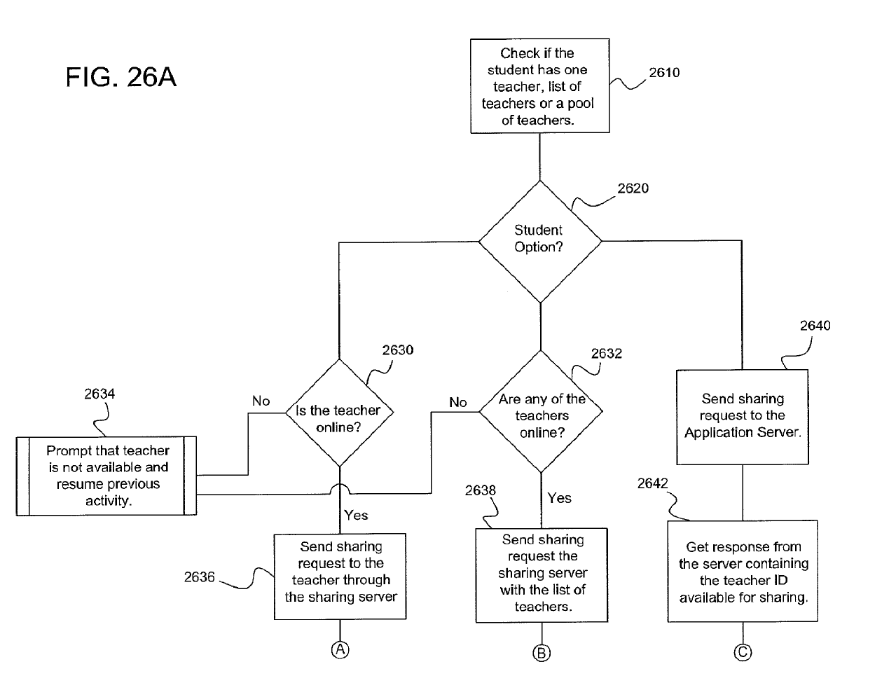

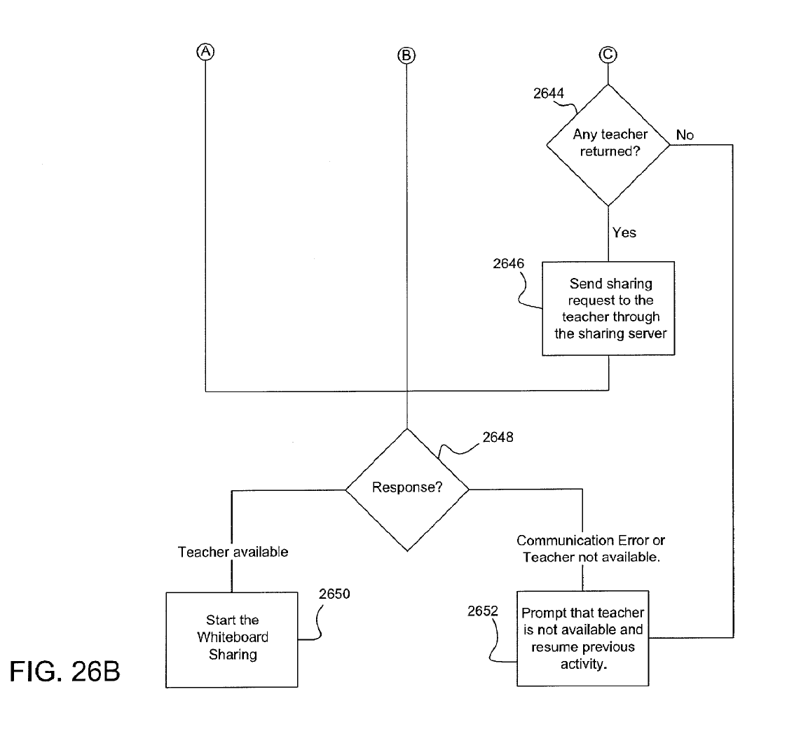

This interaction can be customized to associate a student with multiple specific teachers or even with a pool of teachers. Upon the student clicking the live tutoring session button 550, the student module requests the application module 130 for the teacher ID with whom a sharing session can be started. The process used by the application module 130 to select a teacher ID is shown in FIG. 26. The student module 140 then contacts the sharing module 150 to establish a connection with the teacher.

Timing Measurements

In some embodiments, timing is tracked by the student module 140 at two levels, the question level timing and scribble level timing. When a worksheet is downloaded from the application module 130, it indicates the expected time for completing the worksheet. The application tracks the time taken for each question and keeps a running track of the total time taken by the student for solving the worksheet. This time stamp information may be displayed to the student when attempting the questions in the worksheet and may be updated at some predetermined interval, every minute. These updates can also be performed every second or in multiples of seconds or in any measure of time as determined by the customer.

Further, the application can optionally track the time taken for the student to start the first scribble, the time taken for each scribble, and the time between each scribble. As used herein, a “scribble” is a contiguous handwritten segment input by a user, e.g., via a tablet-like input device. In other words, the start of a scribble is a pen-on event, the end of a scribble is a pen-off event, and the scribble itself corresponds to the electronic pen/stylus (or suitable input device for providing freeform input, e.g., a finger, or a mouse) tracing a pattern on a tablet, for example. In some embodiments, a start time and/or an end time for each scribble is identified and stored. The data gathered is sufficient to reproduce the exact timing of the student's actions. This is useful for academic research and allows the capture of the following data: the time taken to start the first scribble after the question is displayed; the average time taken between consecutive scribbles; the maximum time taken between consecutive scribbles; the average time taken (average duration) for a scribble; and the maximum time taken for a scribble. The time between scribbles may be measured as a difference between the start time of a given scribble and the end time of the previous scribble, the difference between the start time of a given scribble and the start time of the previous scribble, the difference between the end time of a given scribble and the end time of the previous scribble.

In some embodiments, the performance of the student is tracked based on the tracked time of each handwritten segment (scribble). Diagnostics may then correlate student performance with scribble timing information. In some embodiments, the performance of a single student is tracked over time, e.g., across multiple problems. For instance, a student may become more fluent at answering problems over time and produce scribbles at a faster rate (e.g., less time between scribbles, less time for a given scribble, etc.). In some embodiments, tracking performance just involves tracking accuracy of responses rather than timing information of scribbles. In some embodiments, the performance of the student is tracked across multiple worksheets each containing at least one problem. Performance may also be tracked across different subjects (e.g., mathematics, history, etc.) associated with the curriculum plan. The performance of one student may be tracked relative to another student or a group of other students.

Live Answer Verification and Dynamic Feedback

When a student transitions out of a question, the application can optionally verify the answer (e.g., from a digital answer pad, from multiple choice inputs, through character recognition on the answer area scribble input and other modes of user input). This student answer then is compared against the answer generated or provided for the relevant question in the worksheet (as downloaded from the application module 130).

if the answers do not match, the student module 140 may prompt the student to rework the problem, view a virtual lesson for this question, or move on to the next question. This technique allows the student module 140 to provide instant feedback to a student in some embodiments.

Stealth Viewing

The SSRT 250 is launched once the student is logged in to the application module 130. The SSRT 250 registers the student with the sharing module 150 and then waits for messages from the sharing module 150. All the messages from the sharing module 150 are handled by the SSRT 250. Scribble actions from sharing sessions may be applied to respective virtual whiteboards, which are described further below.

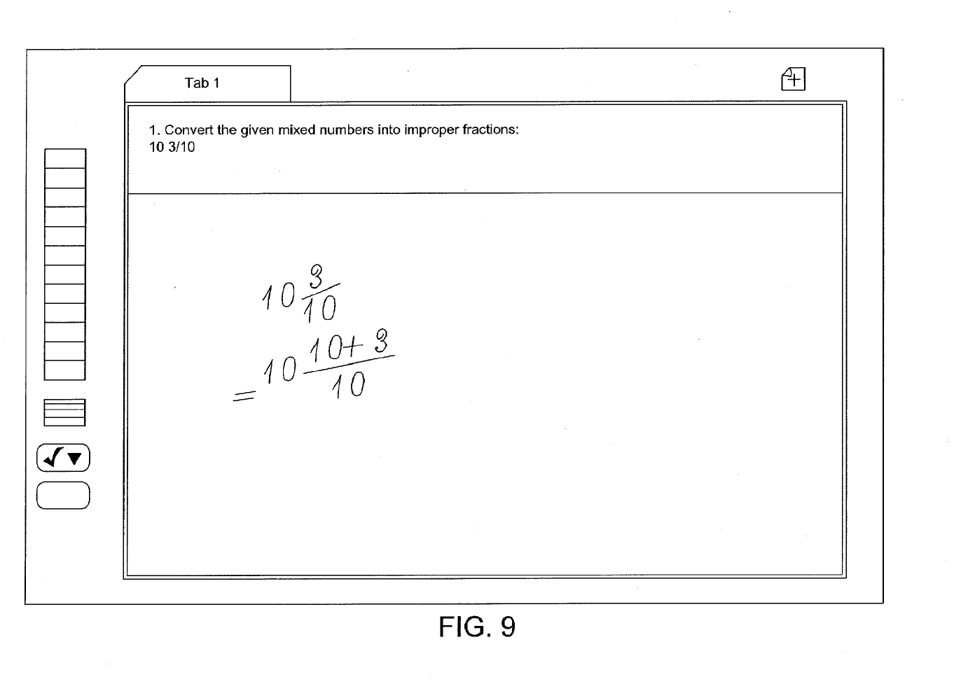

In addition to these actions, the SSRT 150 on the student module 140 may also receive an incoming request for a stealth session from a teacher. A stealth session is a one-way session where the student's scribbles (in the worksheet view) are sent to the teacher module 160 through the sharing module 150. In stealth mode, the subordinate module 140 does not indicate to the student that the teacher is viewing his/her handwritten input in real-time. The student may optionally be notified that the teacher is monitoring his/her work, i.e., stealth mode can be changed to a “normal one-way” mode. In one-way mode, data is sent in only one direction, e.g., from a student to a teacher, with the one-way mode capable of being stealth or non-stealth (i.e., “normal”). Once a stealth session is initiated, all scribbles, text activities, and question transitions are sent from the student side to the teacher, enabling the teacher to see the student's screen (e.g., as in the depiction of the example display shown in FIG. 9) and the actions he/she performs within the scribble and text areas without the student being aware of the teacher's presence.

Viewing Graded Worksheet

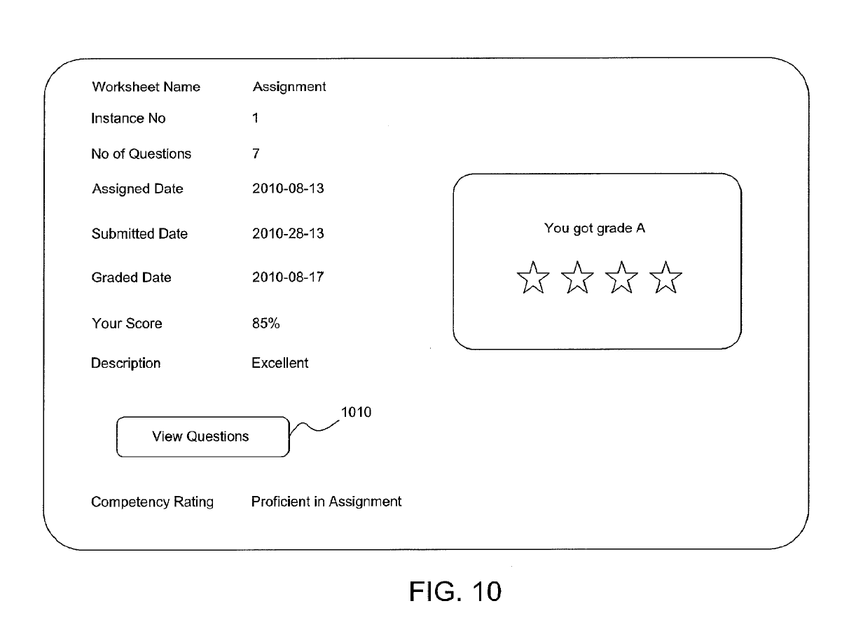

In some embodiments, a student is able to select a graded worksheet in a worksheet list view and view it. The overall performance of the student in solving the worksheet can optionally be displayed here, as in FIG. 10, which is a depiction of a sample display of a student's grade and performance. If there is any associated grade rating, that information is also shown. After viewing the summary information, the student may view the list of all the questions in the worksheet via a button 1010, which list identifies questions that were incorrectly answered, questions on which a teacher has written some comments, and questions where there is an audio response from the teacher.

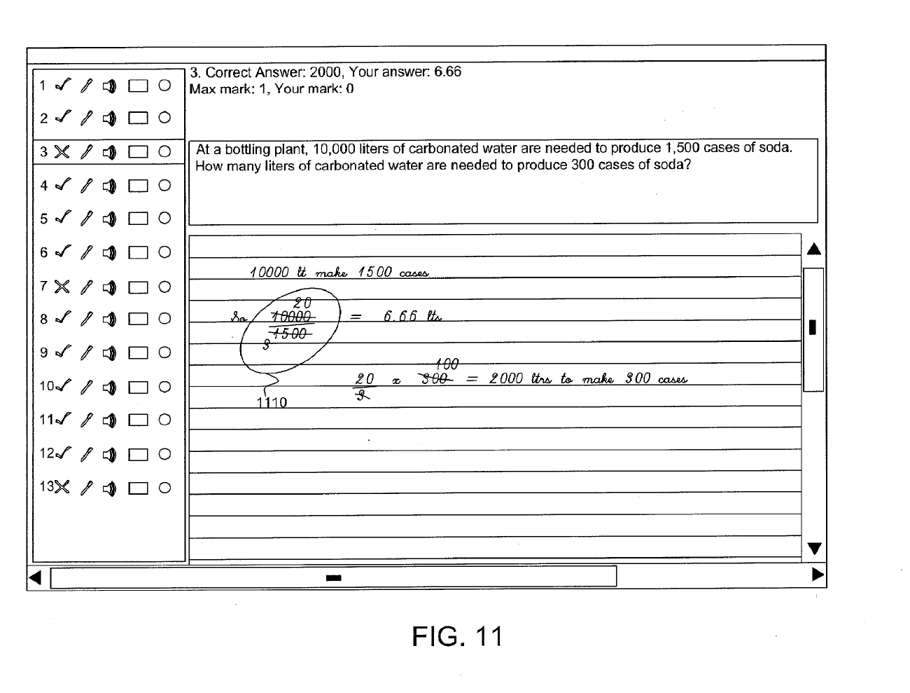

In some embodiments, the student is able to see the following for each question: the original question as shown to the student in the Worksheet Display View, including reference pages; the student's own scribble/text and digital answer; the correct answer to the question; the teacher's corrections and comments either in the form of scribble or text, as indicated by the markup 1110 in FIG. 11; the student's audio questions, if any, a teacher's audio response or feedback, if any, and a teacher's video response or feedback, if any. From the Graded Worksheet View the student will be able to navigate to any of the questions in the relevant worksheet.

Teacher Module

The internal components of the teacher module 160 are similar to those of the student module 140 and do not require substantial separate description or a separate figure. The teacher module 160 includes a local data store, a UI thread (similar to UI thread for 260 described above in the context of the student module 140) for interaction with the user, an ASIT to interact with the application module 130, and a SSRT to interact with the sharing module 150. The teacher module 160, like the student module 140, may be implemented to provide platform independence. For example, a language such as Java may be used to provide such platform independence. The teacher module 160, like the student module 140, uses asynchronous login, uploads, and downloads to provide the capability of operating with sporadic network connectivity. Implementations of different features of the teacher module 160 are described below.

Asynchronous Login

The asynchronous login mechanism used by the teacher module 160 is similar to that used by the student module 140 as described in detail above in FIG. 3. The difference is in the data that is downloaded. The teacher module 160 downloads the following data listed in Table 4 into its data store at the successful completion of login.

TABLE 4
Data downloaded by teacher module

Login ID and password of the user.
List of newly submitted worksheets for the teacher to grade. The ASIT
optionally requests the download of these worksheets from the application
module 130 and adds these worksheets to the worksheet list for the
student.
List of deleted worksheets. ASIT checks if any worksheet that has already
been downloaded, is deleted in the application module 130 (presumably
by an administrator), then the local copy will also be deleted.
The list of courses and classes that this teacher is a part of.
The list of students and teachers who are contacts for this teacher. This
will include all the students in the courses that the teacher is handling.
The class schedule for the teacher.

As in the case of the student module 140, once the login process is complete for the teacher module 160, the teacher module's SSRT is launched. If there is a login failure at the application module 130, the teacher module 160 will prompt or warn the user and shut down.

Class List Display

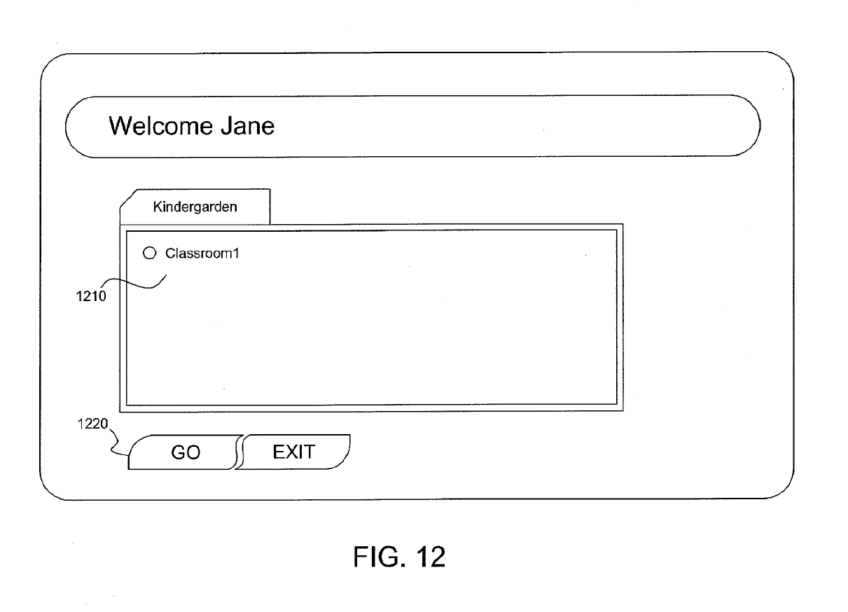

Once the login is complete, the UI thread of the teacher module 160 displays a class list for the teacher. FIG. 12 is a depiction of a sample display of a class list 1210. The teacher is able to select a classroom and enter the virtual classroom. The selection of the classroom may also be scheduled, in which case the application may automatically prompt the teacher when it is time to enter a classroom. The teacher may also choose to enter the class, which announces the teacher's presence to all the class students and also allows the teacher to monitor the activities of students in all his/her classes. The teacher selects a class room and enters it by clicking the “Go” button 1220.

Class Student Display

A sample of the Class Student Display is shown in FIG. 6. The following items listed in Table 5 are shown to the teacher in this display.

TABLE 5
Items shown to teacher in Class Student Display

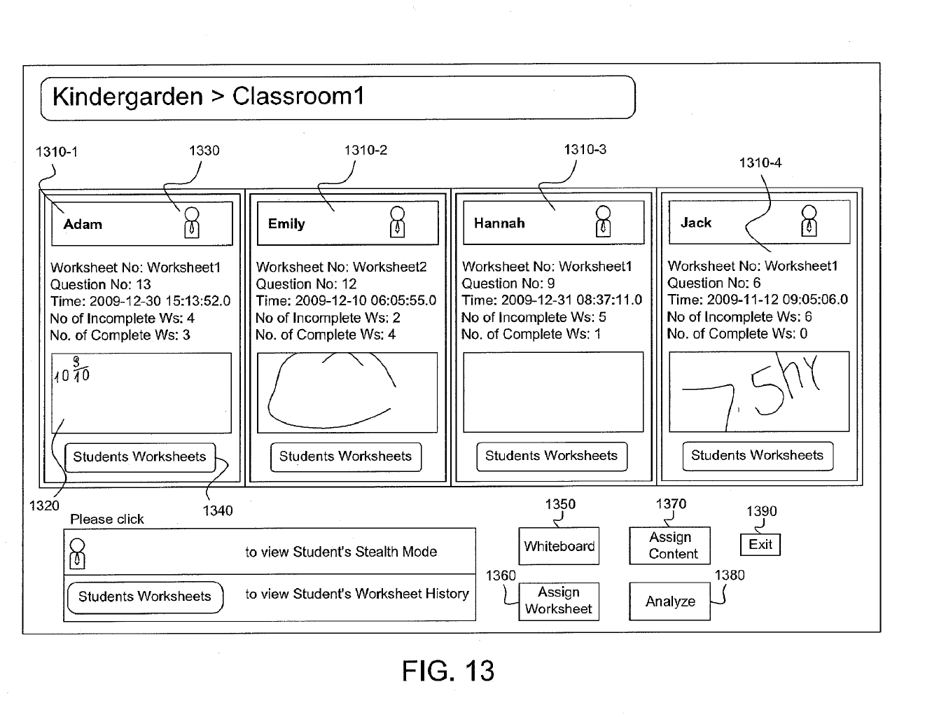

The list of students in the class. Portions 1310-1, 1310-2, 1310-3, and 1310-4 (generally
1310) are shown in FIG. 13 corresponding to four students.
Optionally for each student, a thumbnail 1320 is displayed of the last uploaded bitmap
showing scribble activity. Bitmaps are uploaded to the application module 130 when the
student transitions out of a question. The thumbnail 1320 showing a portion of the scribble
input for a particular student may be periodically refreshed by the teacher module 160. In
some embodiments, the refresh rate is high enough to provide a relatively smooth sequence
of images for the teacher; in other embodiments, a relatively low refresh rate (e.g., once per
some number of seconds) is used. Thumbnails for all students are not labeled in FIG. 13 for
convenience only. Other forms of student input (audio/text/video) may also be viewed by
the teacher.
The online status of the student, as obtained from the sharing module 150 and as shown by
an icon 1330.
List of submitted worksheets waiting to be graded for each student, accessible via a button
1340. Clicking on button 1340 launches the process of grading the worksheet.
Buttons/Links to initiate the following actions:
Click on the online icon 1330 to view the student's activity in stealth mode. From
the teacher module's point of view, the stealth mode is just the shared whiteboard
in a “receive only” setting. In stealth mode, the teacher is not able to write to the
shared whiteboard.
Select the student and click on the whiteboard icon 1350 to start a whiteboard
session with the student. This is described under the Sharing Component section.
Buttons to select all students and unselect all students. These buttons may be the
same as portions 1310.
Select students and click the Assign Worksheet button 1360 to assign a new
worksheet to the selected students. The teacher in this case will need to select a
worksheet already created and assign it to the class. The worksheet can be
selected by specifying filtering criteria.
Select students and click Assign Content button 1370 to assign contents to be
read by the class or selected student. The contents can be selected by specifying a
filtering criteria. Content can also be specified by directly providing a uniform
resource locator (URL). Normal curricular content for a course the class is taking
would be directly assigned by a learning management system and should not
require manual intervention by the teacher.
Select a single student and click on the “Analyze” button to look at and analyze
the past performance of a student. This is described in the student view below.
Button 1390 to exit the class.

The two main activities launched from this view—grading worksheets and analyzing the performance of a student—are described in detail below.

Grading a Worksheet

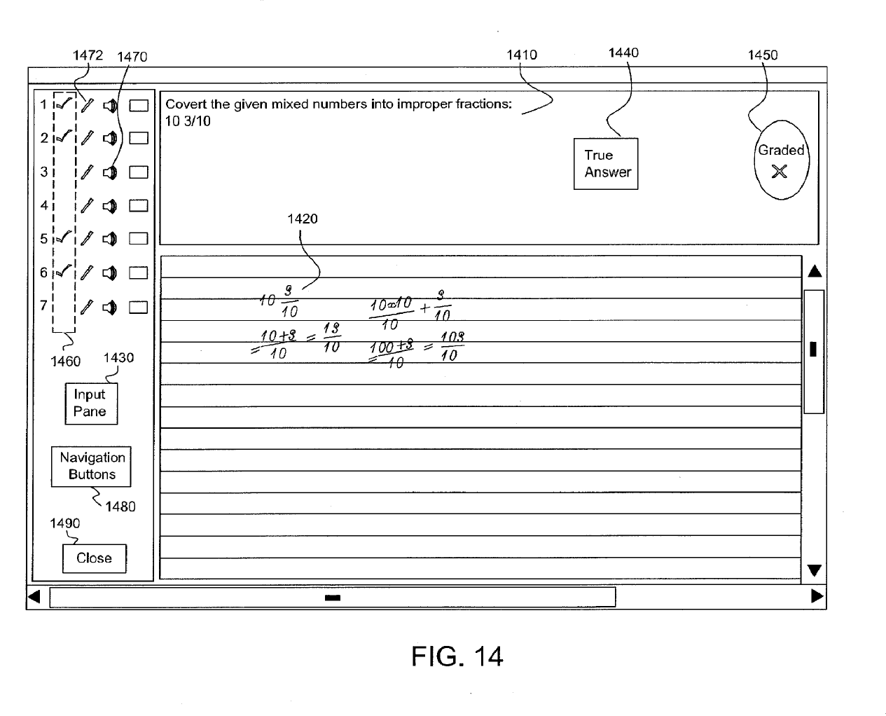

Selecting the worksheet to be graded in the Class Students View brings up the first question in the worksheet. FIG. 14 provides a sample of how this may look. The UI elements present in this view are listed in Table 6.

TABLE 6
UI elements displayed while grading worksheet

Display of the question text 1410 and any reference page.
Display of the student's scribble and/or text inputs 1420. Scribble inputs 1420 are shown in
FIG. 14, although text inputs may be present.
Input pane(s) 1430 for selecting the pen style, pen color, font size, font type, font color, etc.
for teachers to provide electronic input via scribble or text that is typed or otherwise
selected in a non-free-form manner. The teacher can write his/her feedback onto the same
scribble/text area of the student. As described above regarding the student module 140,
these responses of the teacher will be layered on top of the student's writing so that the
teacher's erase or clear actions will not have any effect on the student's writing.
Display of the scribble answer area, digital pad or multiple choice inputs. This will show
the student's answer.
Display of the correct answer 1440 for the question from the application module 130. This
includes an indication 1450 of whether the question is already graded or not.
Button(s) 1460 for the teacher to indicate whether the question is answered correctly or not.
The teacher may also override the application module's auto correction.
Indication 1470 of whether there is an audio question from the student. Another button
1472 for the teacher to record an audio response. This audio response will be uploaded to
the application module 130 once recorded.
Buttons 1480 for navigating through the questions including previous, next, next
uncorrected question, next question with incorrect answer etc. If the question is not graded
when the teacher attempts to navigate out of the question, the teacher will be prompted that
this is still not graded and will be given an option to grade this question. When the teacher
navigates out of a question, the teacher's scribble will be uploaded to the application
module 130.
A close button 1490. When the teacher selects this, the application will check to see if all
the questions have been graded. If they have been graded, then the teacher will be given the
option to submit the graded worksheet. This will mark the worksheet as “graded” in the
application module 130. The local copy of the worksheet may be erased.

The UI thread in the teacher module 160 also sends upload requests to the ASIT, and the actual upload to the application module 130 takes place from the ASIT of the teacher module 160. Similarly, upload requests are also tracked in the local copy. If the application is closed before the “uploads” are completed, this process enables the application to complete all the incomplete “uploads.”

In some embodiments, the supervisor module 160 is configured to receive from the teacher audio feedback about the student's response, which feedback is transmitted to the subordinate module 140 for outputting to the student.

Student Worksheet Analysis

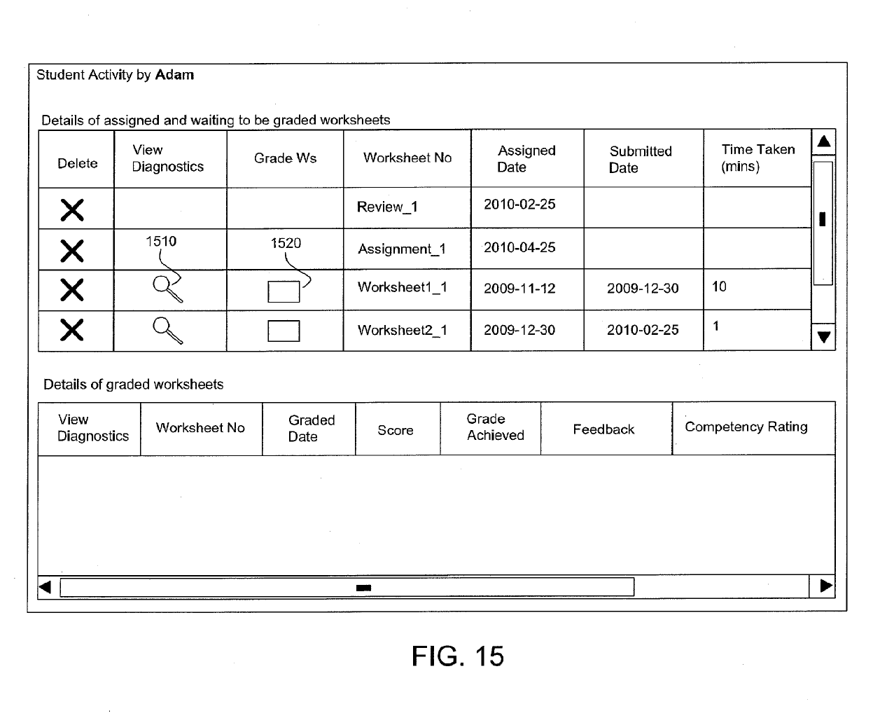

The teacher has the option to view and analyze the performance of the students at a question level and at a worksheet level. FIG. 15 is a depiction of this view. A button 1510 provides the option to view diagnostics regarding a student. A button 1520 provides the option to grade a worksheet. The teacher may view the following items when he/she makes a selection to view the student details from the Class Students Display: the list of worksheets assigned to the student, where the status of the worksheet may be assigned or submitted; the list of worksheets that are graded and the grading details for this worksheet; buttons and menus to perform the actions given below.

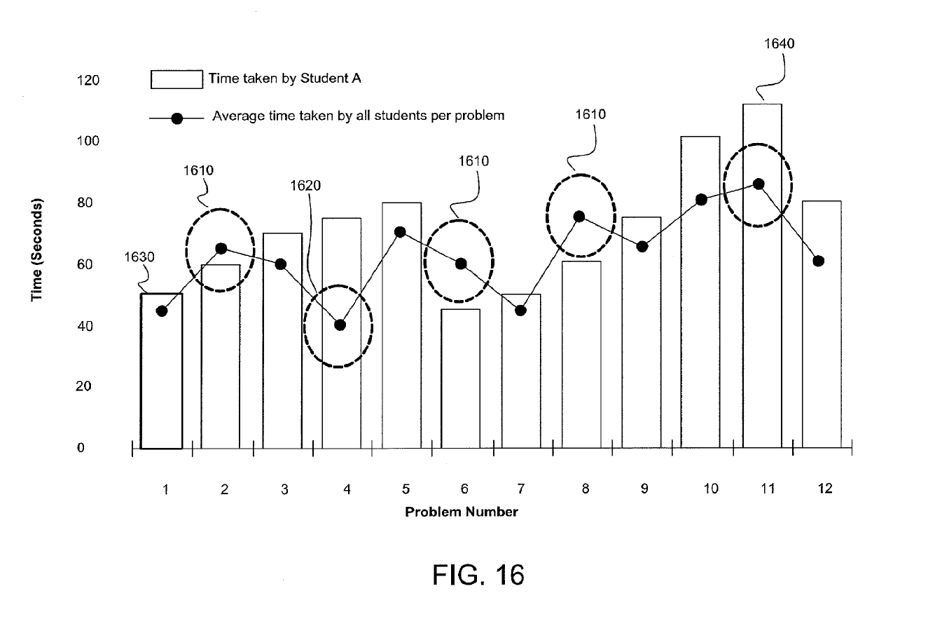

The teacher may perform the following actions: select a worksheet and see the details of the worksheet like number of questions, number of answered questions, number of questions that are automatically graded, number of questions that are correct, number that are wrong, the course grade; view the historical scores of the students and compare them against the averages for the class; view the time taken by this student for the various questions and also the first scribble time and compare them against the average times for the class; assign a worksheet to a student or delete an already assigned worksheet. FIG. 16 is a depiction of a sample view of a graph of time taken by a student for various problems/questions. FIG. 16 additionally shows the average time taken by all students per problem, problems 1610 where the student demonstrated better performance than the class average (e.g., in a statistically significant sense), problems 1620 where the student demonstrated worse performance than the class average, and problems 1630 and 1640 that every student in the class answered correctly and incorrectly, respectively.

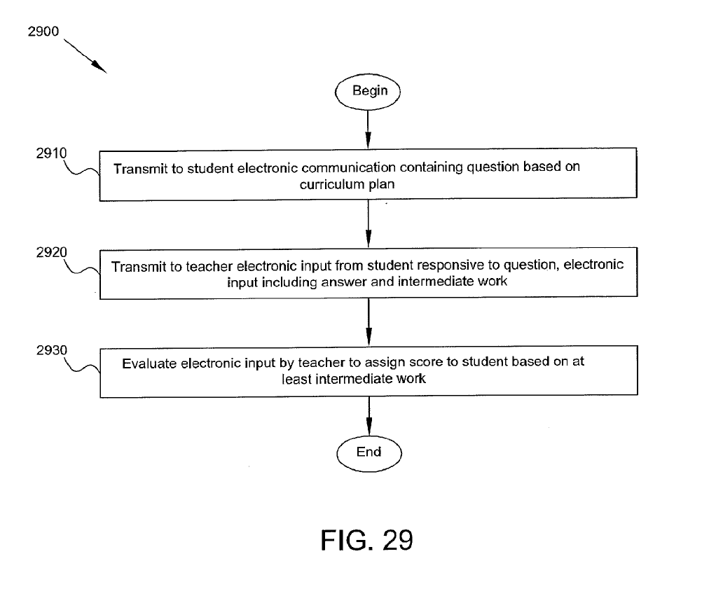

FIG. 29 is a flow diagram of a process involving testing a student in accordance with some embodiments. After process 2900 begins, an electronic communication is transmitted to a student at 2910. The electronic question contains a question based on a curriculum plan. The curriculum plan may be any scheme in an academic context that provides for instructing and/or testing students on one or more topics. An electronic input from the student responsive to the question is transmitted to a teacher at 2920. The electronic input includes an answer to the question and intermediate work related to the answer. The electronic input has an input modality selected from the group consisting of handwritten input, audio input, and video input. At 2930, the teacher evaluates the electronic input to assign a score to the student based on at least the intermediate work. A deficiency of the curriculum plan may be identified based on the intermediate work. For example, a teacher may observe that students are systematically providing correct intermediate work but incorrect answers (or vice versa) and may identify a shortcoming in test problems, taught content, or other pedagogical attributes that may be implicated. If an entire group of students answers a question incorrectly, for example, the fault might not lie with the students but rather with the teaching methods used.

In some embodiments, when a student selects a lesson within the curriculum plan in a virtual classroom environment, the student selection is tracked. Learning characteristics of the student may then be determined based on the student's choice of lesson or based on intermediate work provided by a student in response to a question. For example, if the student tends to select mathematical lessons or writing lessons, or if the student proceeds through the correct steps in solving a problem but consistently provides incorrect final answers for some reason, appropriate conclusions may be drawn based on such selections or such intermediate work. Various embodiments support identification of a student's learning style, e.g., whether the student is a visual a or an aural learner who learns better by healing.

Sharing Component

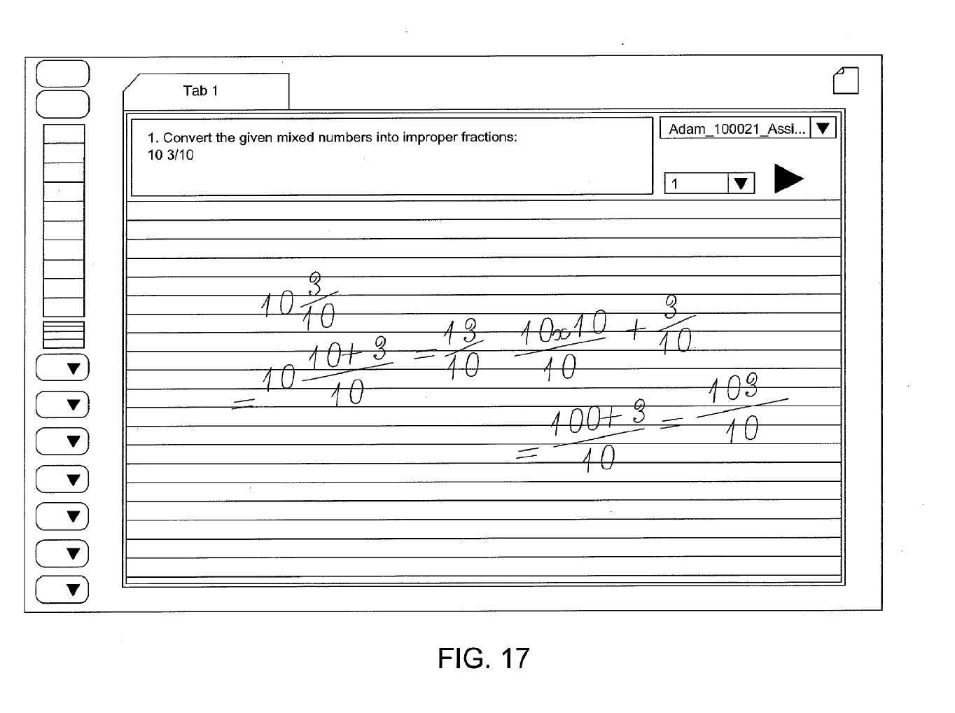

The sharing module 150 is a common component that can be accessed from both the student module 140 and the teacher module 160. Before invoking this sharing component, the student/teacher application would have received input from the user or from the application module 130 about a user with whom communication/collaboration is desired. Then, a shared session (virtual whiteboard session) is launched for that user. FIG. 17 is a depiction of a shared virtual whiteboard. The shared module 150 functionality is largely the same for both students and teachers. The differences are identified in the description below.

Multiple sharing sessions may be active at the same time, each with different users. The sessions can be launched by one user towards another user or vice versa. For example, a request for real-time collaboration may be initiated by a student or a teacher in a virtual classroom environment. Once launched, the behavior of the sharing session is independent of whether it was locally launched or remotely launched.

The implementation of the sharing is premised upon certain properties. A communication channel exists between the local user and one or more remote users. This can be direct or peer-to-peer communication channel or a channel that is routed through a sharing module 150. The communication channel is one that is reliable for whiteboard sharing, application sharing, scribble instant messaging (IM), etc. The communication channel is be isochronous but follows Unreliable Data Transport protocol for audio and video channels. The communication is not network or platform dependent. Users on the two sides may be on different types of networks (e.g., Wi-Fi to DSL to Internet, 3G to internet, LAN to cable modem to Internet, etc.) and on different types of platforms (Windows PC, Mac PC, various smartphones, etc.).

Shared Whiteboard

A sharing session may include audio and video. FIG. 10 is a depiction of a sample display of a shared virtual whiteboard. The shared whiteboard allows for shared editing of a whiteboard as well as shared editing of a text document. The shared whiteboard provides the features present in the scribble functionality and the text functionality of the student module 140 and teacher module 160, including the following: line thickness, format and color selection; font type, size and color selection; shapes and connectors; erase, clear, undo and redo; pointer arrow and highlighting.

The shared whiteboard converts every event that has an impact on the screen of one user and sends these as actions to the users on the other side of the communication channel. The action is sent when a single scribble is completed. As described above, a single scribble is the writing on the screen from the time the pen (or other suitable instrument, including a finger) hits the writing surface to when it is lifted off. So it is a continuous line. Sending the data a scribble at a time rather than as pixels from the subordinate module 140 or supervisor module 160 to the application module 130 ensures frequent refreshes without overwhelming the network. In other words, storing and transmitting individual scribbles rather than an entire bitmapped image with all pixels reduces load and improves performance. Similarly, when the shared whiteboard receives these actions from other users, it applies these on to the screen of the current user.

The shared whiteboard further supports multiple pages. Each page may be chosen to be a text page or a scribble page. Page creation and deletion is also synchronized across the two sides like other whiteboard actions.

In sonic embodiments, the shared virtual whiteboard is at least initially oriented around a contextual topic determined by one of the collaboration participants, with the contextual topic providing a subject for the collaboration. For example, in a virtual classroom environment, the whiteboard may be oriented around a particular question or worksheet, e.g., due to a student or teacher selecting a particular question or worksheet for a whiteboard session. In some embodiments, a drop-down menu or similar GUI element is provided to enable a teacher or student to change to a different contextual topic during collaboration. Thus, in contrast to known whiteboards that only allow information to be entered on top of a completely empty (white) screen, various embodiments allow a rich infrastructure for collaboration.

The shared whiteboard also allows the upload of old questions and their answers into a whiteboard page. By selecting any of the worksheets that are available in the local store, both teachers and the students can upload questions and their answers to the page. Like with the student module 140 and the teacher module 160, the question text and images are loaded to a background layer which cannot be erased or cleared. In some embodiments, the only way to erase these is to close the page.

The shared whiteboard also allows an external document or image to uploaded, e.g., as a background image in a page. The teacher and student may to scribble on top of this background image (base layer of content). A participant in a whiteboard session may upload a link to data stored externally, e.g., data on the Internet.

A virtual whiteboard in various embodiments provides layering functionality as described above. The whiteboard may further allow users to add multiple scribble layers for the same page. The creator of these layers can associate these layers arbitrarily with users. In some embodiments, each layer is associated with exactly one user. A single user may be associated with multiple layers. Only the user associated with a particular layer is able to edit that layer. Other users (not associated with that layer) are only able to view the changes modifications at that layer).

In some embodiments, the subordinate module 140 or the supervisor module 160 provides an indication of other user(s) currently available for real-time collaboration. In other words, the online status of other users is automatically detected and provided to a user.

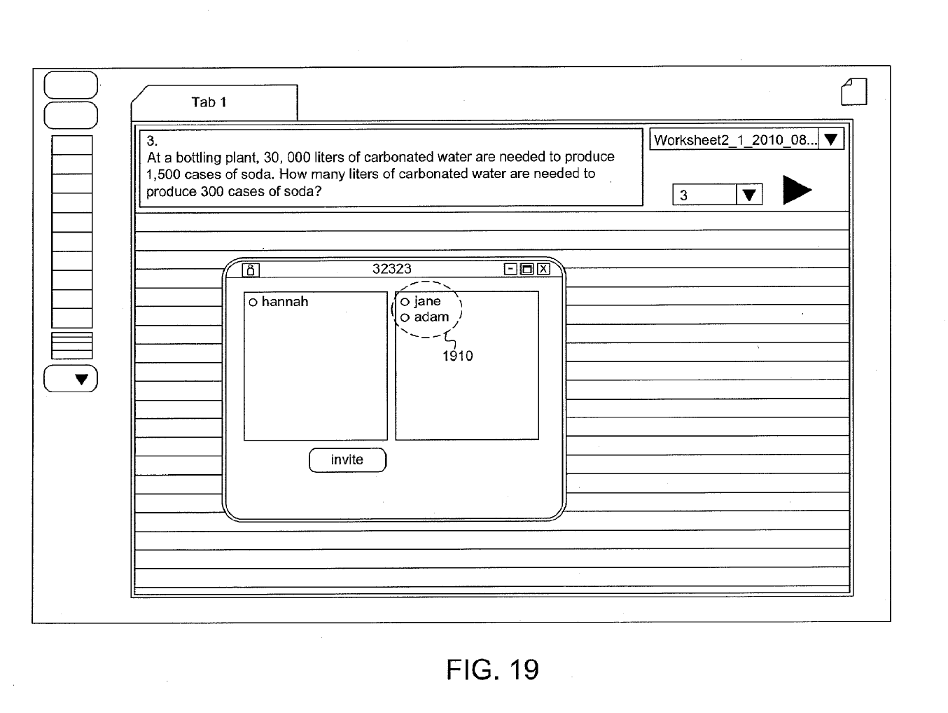

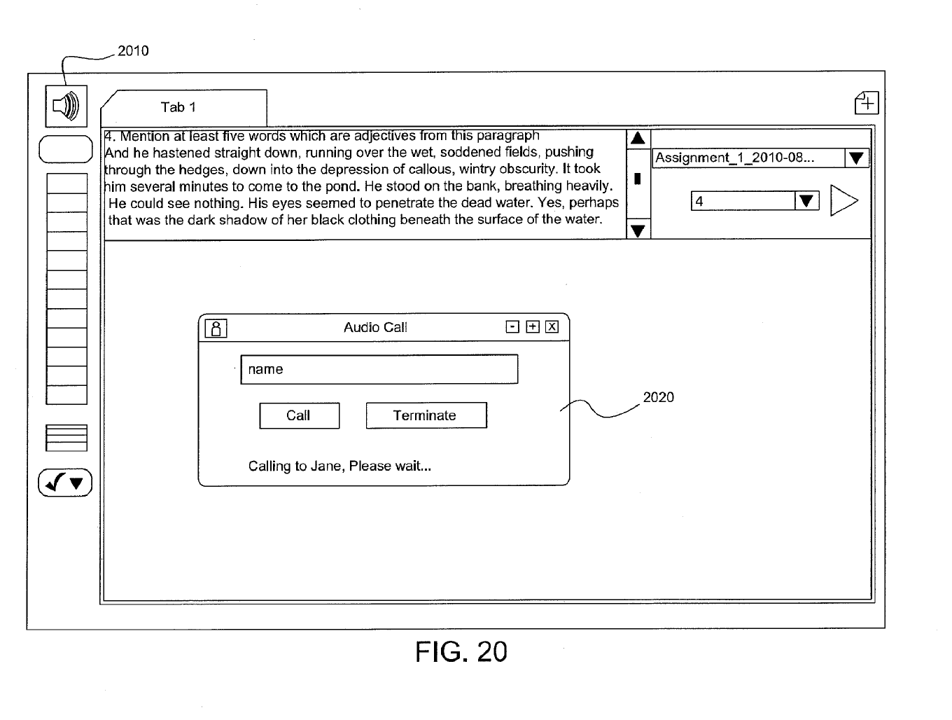

FIG. 19 is a depiction of a sample display for adding parties to a collaboration session. FIG. 19 shows a list of potential participants 1910 to invite to a collaboration session. Any number of participants may collaborate using a virtual whiteboard, and the participants may be students, teachers, or combinations thereof.

An audio call may be established between participants in a collaboration session, as shown in FIG. 20. Clicking an audio call button 2010 invokes an audio call window that a participant uses to invite another participant to join an audio call.

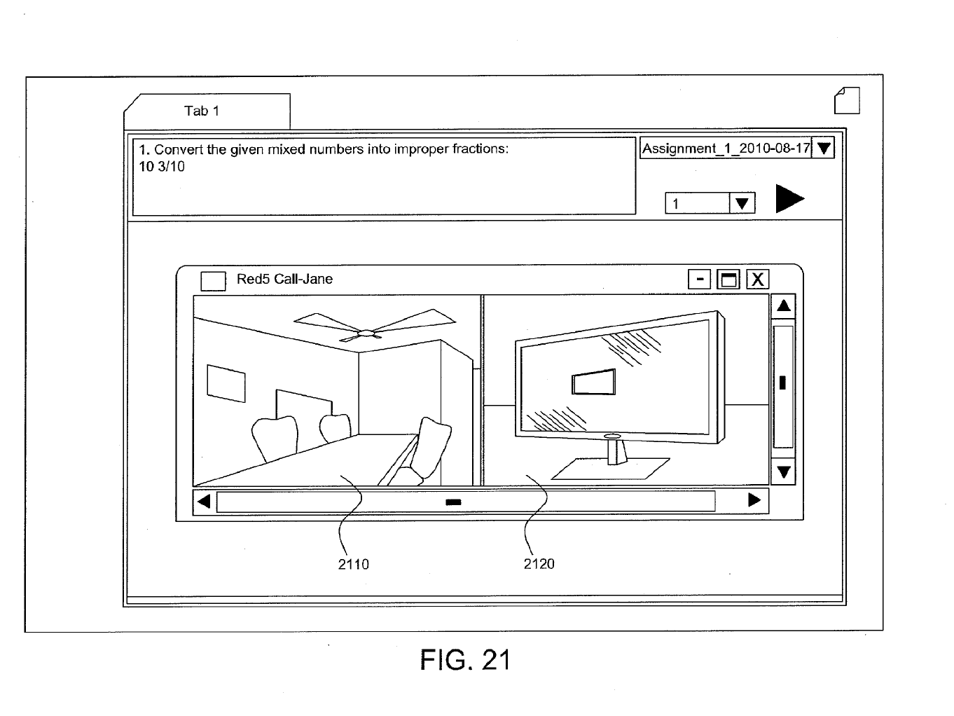

A video call may be established between collaboration participants, as shown in FIG. 21, Separate windows 2110 and 2120 show respective video feeds for a first user and a second user.

Scribble IM

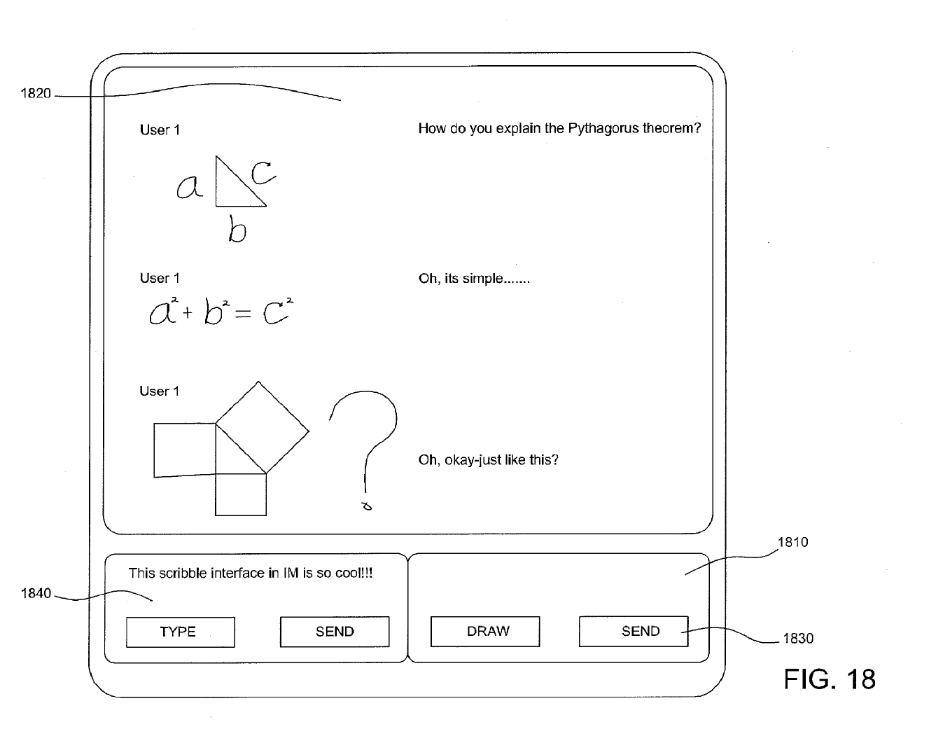

Instant Messaging (IM) is a feature supported by most communication and collaboration software where the communication is typically made using a keyboard. Embodiments of the present disclosure provide instant messaging employing scribble (electronic handwritten input). FIG. 18 is a depiction of a sample scribble IM display, An area 1810 is provided for a user to scribble Instant Messages (IMs), and a scrollable area 1820 shows the historical IMs. Standard scribble controls, e.g., for specifying scribble thickness, color, etc.) may be provided for the scribble IM. In a scribble virtual whiteboard the actions are sent each time the pen is lifted from the writing surface. In contrast, with scribble IM, such an action is sent only when the user hits the send button 1830. When the send button is hit, a list of scribble actions is sent to the other user. The coordinates in the actions are all with respect to the scribble area. Received scribble IMs are drawn into the historical area 1820. An area for typing 1840 may also be provided.

Scribble Message Board

In some embodiments, default virtual message boards are created, and users are established as members of the message boards. The message boards may be synchronous, e.g., as in instant message (IM) boards, or asynchronous. A synchronous message board is a multi-party scribble IM chat. For instance, all students and the class teacher may belong to a default group. Similarly, all students taking a certain course may belong to a group for that course. Besides these default groups, users can also create groups and populate them with members of their choice.

Members of the group can post articles to these groups. Postings to the scribble message board may be in the form of scribbles instead of typed texts. The student may optionally provide a typed text subject to the message. The virtual message board may include a visual indication of at least one problem or at least one response by a student to a problem.

When a user (student or teacher) chooses to view a message board, the most recent N messages (N is configurable by the user) or messages from a recent time period (configurable by the user), whichever is a fewer number of messages, are displayed. The users can view older messages by selecting a date range or by searching using the message poster's name, words in the subject, etc. By clicking one of these messages, the full, scribble message will open in a new display tab. The user can reply to this message.

Application Module and Database

The application module 130 may be implemented as a Java servlet based web server running in a Tomcat servlet container. The backend may be implemented in a SQL database. Table 7 lists the requests handled by the application module 130 and its actions.

TABLE 7
Requests handled by application module and relevant actions

| | | Invoked | |
|---|---|---|---|
| Servlet | Parameters | By | Description |
| Login | UserID | Student | See below for a description |
| | Password | and | of the Login process and |
| | | Teacher | the response construction. |
| | | Modules. | |
| DownloadWorksheets | Student No | Student | It matches worksheets in |
| | Worksheets | Module | database and downloads the |
| | | | matched worksheets as |
| | | | response. |
| UploadQuestion | Student No | Student | It will store the student's |
| | Worksheet No | Module | answer into the database |
| | Instance No | | 120 and store the scribble |
| | Assigned Date | | image in the application |
| | Question No | | module 130. This is |
| | Answer | | invoked every time the user |
| | Image data | | transitions from a question. |
| | AutoCorrection | | |
| | Timing details | | |
| UploadAudio | Student No | Student | The audio file is uploaded |
| | Worksheet No | Module | into the application module |
| | Instance No | | 130 and stored into the |
| | Assigned Date | | database 120. This is |
| | Question No | | invoked when the student |
| | AudioFile | | asks an audio doubt. |
| WorksheetSubmission | Student No | Student | Worksheet status is |
| | Worksheet No | Module | changed into submitted |
| | Instance No | | state and the time taken for |
| | Assigned Date | | the worksheet is stored in |
| | TimeTaken | | the database 120. |
| GetGradedWorksheet | Student No | Student | It matches the graded |
| | Worksheet No | Module | worksheet in the database |
| | Instance No | | 120 and obtains the graded |
| | Assigned Date | | worksheet details and |
| | | | questions details, and |
| | | | teacher audio responses. |
| ClassStudentsDetails | Teacher No | Student | It matches the class number |
| | Class No (class | and | in the database 120 and |
| | number) | Teacher | retrieves all the students, |
| | | Module | worksheets information |
| | | | (just their IDs) in matched |
| | | | class number as response. |
| UpdateClassDetails | TeacherNo | Teacher | This retrieves the current |
| | ClassNo | Module | thumbnail view of the |
| | | | activities of all class |
| | | | students for display by the |
| | | | Teacher Module. It |
| | | | retrieves the last uploaded |
| | | | question details (question, |
| | | | answer scribble, audio |
| | | | question and the time of last |
| | | | upload) for each student in |
| | | | the class. |
| AssignWorksheet | Worksheet No | Teacher | Assign a given worksheet to |
| | Instance No | Module | selected student or all |
| | ClassNo, Student | | students in a same class. |
| | Nos, AssignDate | | |
| GetSubmittedWorksheets | Class No | Teacher | It matches that student |
| | Student No | Module | submitted worksheets but |
| | | | not graded in database and |
| | | | worksheets details as |
| | | | response. |
| GradeQuestion | TeacherNo | Teacher | Store the question grading |
| | Student No | Module | information into the |
| | Worksheet No | | database. |
| | Instance No | | |
| | Assigned Date | | |
| | Question No | | |
| | ImageName | | |
| | Image data | | |
| | CorrectionStatus | | |
| SubmitAsGradedWorksheet | TeacherNo | Teacher | Change the worksheet |
| | Student No | Module | status as graded in the |
| | Worksheet No | | application module 130 |
| | Instance No | | |
| | Assigned Date | | |
| AudioResponseToStudent | TeacherNo | Teacher | Store audio file in the |
| | Student No | Module | application module 130 and |
| | Worksheet No | | point the appropriate |
| | Instance No | | database entry to this file. |
| | Assigned Date | | |
| | Question No | | |
| | AudioFile | | |
| GetStudentGradedWorksheetsList | Class No | Teacher | It matches student graded |
| | Student No | Module | worksheets for the given |
| | FromDate | | date range in database and |
| | ToDate | | worksheet details as |
| | | | response |
| GetWorksheetTimingDetails | Class No | Teacher | Get all the timing details for |
| | Student No | Module | the student and class for the |
| | Worksheet No | | specific worksheet |
| | Assigned Date | | submission. |
| RemoveWorksheets | Class No | Teacher | Remove Student Assigned |
| | Student No | Module | worksheets from the |
| | Worksheet Nos | | application module 130. It |
| | Instance Nos | | matches the worksheets in |
| | AssignedDates | | database and change the |
| | | | worksheet status as non |
| | | | gradable. |
| ViewStudentWorksheetHistory | Class No | Teacher | Get student worksheet |
| | Student No or all | Module | history from the database |
| | students | | 120. |
| AddSample | Worksheet No or | Teacher | Given sample is stored into |
| | Question Type or | Web | the database 120 and |
| | Question | | uploaded into the |
| | Sample URL or | | application module 130 if it |
| | Sample File | | is a file. |
| CreateWorksheet | Worksheet No | Teacher | Store the worksheet name |
| | No of questions | web | and no of questions into the |
| | | | database 120. |
| CreateQuestion | Question (file | Teacher | Uploaded into the |
| | containing the | Web | application module 130 and |
| | question | | stored into the database |
| | html+images) | | 120. |
| | AnswerType | | |
| | (multiple choice or | | |
| | numerical) | | |
| | AnswerChoices (only | | |
| | if the type is multiple | | |
| | choice) | | |
| | CorrectAnswer (may | | |
| | not be present - i.e, | | |
| | not digital answer) | | |
| | ReferencePageId | | |
| | (optional) | | |
| CreateReference | Worksheet No | Teacher | Uploaded into the |
| | Reference File (html | Web | application module 130 and |
| | file with images | | stored into the database |
| | containing the | | 120. |
| | reference) | | |
| SetWorksheetQuestionType | Worksheet no | Teacher | Store worksheet question |
| | Parameters | web | type information into the |
| | StartQuestion | | database 120. This is used |
| | EndQuestion | | to identify samples. |
| | Worksheet Column | | |
| | Answer Column | | |
| EditWorksheetQuestionType | Worksheet no | Teacher | Update the question type |
| | Parameters | web | information for the given |
| | StartQuestion | | worksheet name |
| | EndQuestion | | |
| | Worksheet Column | | |
| | Answer Column | | |
| AutomatedWorksheetCreate | DocumentFile | Teacher | This process the given file |
| | PageRange | Web | (PDF, Microsoft Word or |
| | | | HTML) and process the |
| | | | tags to create the worksheet |
| | | | automatically as described |
| | | | in section below. |
| DeleteWorksheets | Worksheet No | Teacher | Teacher can remove her/his |
| | | web | own created worksheet |
| GenerateWorksheet | Worksheet No | Teacher | Generate all questions for |
| | Instance No | web | the given worksheet. See |
| | | | detailed description for |
| | | | Worksheet Generation |
| | | | below. |
| RenderWorksheet | Worksheet No | Teacher | Create a worksheet as given |
| | Instance No | web | format (xml or html or pdf). |
| | Format | | See detailed description for |
| | | | Worksheet Generation |
| | | | below. |
| UploadScribbleMessage | MessageBoardId | Both | Downloads a specific |
| | MessageId | Modules | scribble message in a |
| | | | message board. |
| DownloadScribbleMessages | MessageBoardId | Both | This returns count messages |
| | FromMessageID and | Modules | IDs since the last one |
| | Count | | identified here (or the most |
| | (OR) | | recent count messages). Or |
| | FromDate and | | it would return messages in |
| | ToDate | | the date range. |
| GetMessageBoards | UserID | Both | Gets the list of boards that |
| | | Modules | this student or teacher |
| | | | belongs to. |
| CreateMessageBoard | MessageBoardName | Both | Create a message board of a |
| | Open | Modules | given name. It is marked as |
| | | | open or closed. i.e. People |
| | | | can add themselves or only |
| | | | be added by the creator. |
| AddMember | MessageBoardId | Both | Add a member to the |
| | UserId | Modules | message board. |
| DeleteMember | MessageBoardId | Both | Delete a member from the |
| | UserId | Modules | message board. |

Login Process and the Crypt Algorithm

The Login process verifies the login ID and password against the login IDs and passwords stored in the database 120. If this matches it also finds the whether the user is a teacher or student from the database entry for the user. It also stores the user ID in the session property and uses the cookie mechanism provided by the application module 130 (e.g., the web server) to track the session.

For both students and teachers, the application module 130 creates a CRYPT (an encrypted datum) and returns that as part of the response. The sharing module 150 does not have access to the database 120 running on the application module 130. Therefore, the following mechanism is used by the sharing module 150 to verify the identity of the user. The application module 130 appends the user ID, password, the date and time of login and encrypts the appended string using a two-way encryption algorithm like Blowfish. The key used for the encryption is private to the application module 130 and to the sharing module 150.

This CRYPT is sent along with the user ID and password to the sharing module 150 by the student module 140 and teacher module 160. The sharing module 150 is able to decode the CRYPT using the key. Once the sharing module 150 gets the decoded data, it is able to verify the user ID and password. Further, it is also able to check for old/stale information using the date/time information in the CRYPT. This prevents unauthorized users from using the system.

Besides the CRYPT the sharing module 150 sends the following information for students, listed in Table 8.

TABLE 8
Information re: students sent by sharing module

List of newly assigned worksheets' IDs, including the worksheet ID,
the instance number and the assigned date. The assigned date uniquely
identifies the worksheet since the same worksheet may be assigned to
multiple students.
List of newly assigned worksheets' IDs, including the worksheet ID,
the instance number and the assigned date. The assigned date uniquely
identifies the worksheet since the same worksheet may be assigned to
multiple students.
List of worksheets which have been graded since the last login.
List of new contents assigned to the student for reading.
List of classes the student belongs to.
The list of students and teachers who are contacts of this student other
than the students of the classes the student is part of.

In addition to the CRYPT, the sharing module 150 sends the following for information for teachers, listed in Table 9.

TABLE 9
Information sent by sharing module 150

List of submitted worksheets from students in courses for this teacher.
Note both the student ID, the ID of the worksheet, its instance number
and the assigned date will be returned. This ensures unique identification
of the submitted worksheet.
List of worksheets in teacher's computer that have been deleted since it
was downloaded.
List of classes the teacher is a part of.
The list of students and teachers who are contacts of this student other than
the students of the classes the student is part of.

The data is sent back as a formatted page, e.g., as an XML formatted page.

Worksheet States

Worksheets go through several states before being assigned to students and several states after being assigned to a student. The Worksheet Generation description below in Table 10 discusses the states of the worksheet before being assigned to a student.

TABLE 10
Worksheet information

| State | Worksheet ID | Description |
|---|---|---|
| Abstract or | Worksheet ID | Here a worksheet is just a collection of |
| Template | | templated questions with parameters |
| | | specified. |
| Generated or | Worksheet ID, | When a worksheet is directly created by a |
| Created | Instance No. | teacher or is generated from one of the |
| | | available abstract worksheet, it enters this |
| | | state. Since a worksheet may be |
| | | Generated several times, the instance No. |
| | | is required in addition to the Worksheet |
| | | ID. |
| Rendered | Worksheet ID, | The same Generated/Created Worksheet |
| | Instance No, | may be rendered in multiple formats. This |
| | Rendering | identified the rendered worksheet. |
| | Format | |
| Assigned | Worksheet ID, | One of the rendered worksheet formats is |
| Worksheet | Instance No, | assigned to a student. |
| Partially | Assigned Date, | Some of the questions' answers have |
| complete | Student No | been uploaded to the application module |
| | | 130 but the status of the worksheet has |
| | | still not been changed to Submitted. |
| Submitted | | The worksheet status has been changed to |
| | | Submitted by the student |
| | | (WorksheetSubmission request). |
| Partially | | Some of the responses from the teacher |
| Graded | | has been uploaded to the application |
| | | module 130 but the status has not been |
| | | changed to Graded. |
| Graded | | The worksheet status has been changed to |
| | | Graded by the student |
| | | (SubmitAsGradedWorksheet request) |

Worksheet Generation

Table 11 provides definitions relevant to worksheet generation.

TABLE 11
worksheet generation definitions

| Term | Definition |
|---|---|
| Generated or Instantiated | A fully specified question which can be |
| Question | asked to a student, e.g., add 13 + 24. |
| Templated or Abstract | A question specified with variables and |
| Question | parameters, e.g., add a + b where a is in the |
| | range p₁ to p₂ and b is in the range q₁ to q₂. |
| Templated or Abstract | A worksheet that is specified by a list of |
| Worksheet | templated questions with the parameters |
| | specified for generating them, e.g, add a + b |
| | where a is in the rage 1 to 20 and b is in the |
| | range 1 to 50. The template worksheet also |
| | specifies the number of questions to be |
| | generated/instantiated of each templated |
| | question. |
| Generated or Instantiated | A list of fully specified questions. This is |
| Worksheet | still in a database and is not in a format that |
| | can be presented to the students. |
| Rendered Worksheet | A worksheet that has been processed in a |
| | manner that is suitable for display to users |
| | in a variety of forms/formats. |

An example template question in a mathematical context is: solve N₁/D₁+N₂/D₁ to yield A₁/B₁. In this example, N₁, N₂, D₁, D₂, A₁, and B₁ are variables. Valid values for each of D₁ and D₂ are in the range R₁ to R₂. N₁ may have valid values in the range 1 to D₁, and N₂ may have valid values in the range 1 to D₂. In this problem, the parameters are R₁ and R₂. By specifying values for these parameters, these we are specifying a range of questions of a specific nature. For instance, by specifying R₁ and R₂ as 9, the problem becomes one of addition of two regular fractions with single digit numerator and denominator. In other embodiments, rather than specifying a single value for R₁ and one for R₂, each of N₁, N₂, D₁, and D₂ is assigned a set of valid values, and each of those parameters is instantiated (a corresponding valid value is inserted out of the set of possible valid values for those respective parameters) to yield an instantiated question in which the question is fully defined. The answer (including values for variables A₁ and B₁) is fully defined based on the instantiations of N₁, N₂, D₁, and D₂. Thus, a correct answer choice is generated in some embodiments. Specifying mathematical problems in terms of numerical parameters offers a wealth of potential problems that may presented a student.

In some embodiments, questions varying in complexity may be generated by instantiating parameters to valid values of different mathematical categories. For example, one category may be single-digit integers, another category may be two-digit integers, and another category may be real numbers. Various other categories are contemplated as well. In addition to instantiating operands in mathematical expressions, operators may be instantiated in some embodiments. For example, one question may be instantiated as “solve 4+7”, with another instantiated as “solve 4/7”. In some embodiments, the subordinate module is configured to change the complexity of questions based on student responses. For example, if a student answers a simple addition problem involving adding two single digit numbers, the system 100 may then challenge the student to try adding two digit numbers. Question complexity may be decreased as well, e.g., if a student is having problem with a particular type of problem.

In some embodiments, student performance is tracked, and instantiated questions are provided to a student based on the tracked performance. The subordinate module 140 may increase a frequency of presentation to the student of instantiated questions of a parametric question type (e.g., mathematics questions or a specific type of mathematics questions such as multiplication of integers) answered incorrectly by the student, e.g., at a rate exceeding a predetermined threshold. As used herein, “frequency of presentation” refers to how often certain questions are presented relative to other questions. For example, if the student has answered several two digit multiplication problems incorrectly recently, the system 100 may present more such problems to the student. The subordinate module 140 may also increase a frequency of presentation of questions answered correctly or decrease a frequency of presentation of questions answered correctly or incorrectly. In some embodiments, the subordinate module 140 is configured to identify a parametric, question type answered incorrectly by the student (e.g., division of real numbers) and change in response to a different question type (e.g., addition of integers, or possibly a question from a different subject than mathematics). The subordinate module 140 may also change to different parameter(s) or may insert different values for the parameter(s) in response to an incorrectly answered question. In some cases, a different instantiation of a same parametric question type may provide a student varied testing materials and opportunities to adapt and learn from mistakes.

In some embodiments, at least one incorrect answer choice is also generated along with the correct answer choice, e.g., by instantiating A₁ and B₁ to values other than their true (i.e., mathematically correct) values. Providing incorrect answer choices enables rendering worksheets in a format (form) that poses multiple choice answers, e.g., for automatic grading. In some embodiments involving automatic grading, a student's electronic handwritten response is converted to a digital response, e.g., by optical character recognition, and the converted digital response is converted to the answer Choices. Another format than multiple choice questions that does not require instantiating incorrect answers is an open-ended question format. The above question may be displayed in several formats using several deployment mechanisms. For example, a first format may be as a multiple choice question in a website which automatically corrects the answers. A second format may be as a question in a printed worksheet with the correct answer choice in a separate answer key sheet. A third format may be a question in a virtual classroom environment in which responses are automatically graded.

The process of rendering, which is separate from the process of question creation, yields a question in a displayable format suitable for the specific renderer. This is described in detail below.

Worksheet Generation Process

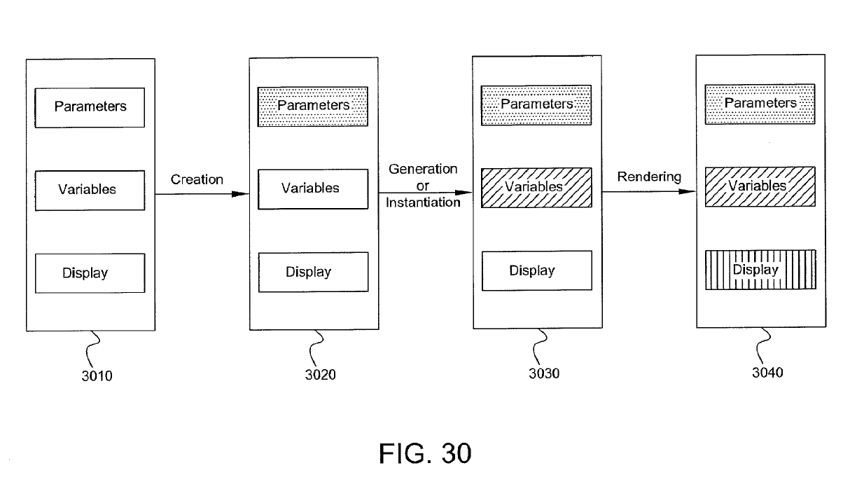

FIG. 30 is a diagram showing how different elements associated with worksheet generation are related. At stage 3010, parameters have not been specified as specific values, variables have not been instantiated, and a worksheet is not suitable for display yet. At stage 3020, questions have been created, as parameters have been specified. At stage 3030, variables have been instantiated (generated), and the worksheet is ready for rendering into a desired form. At stage 3040, the worksheet has been rendered into a particular form, e.g., with questions in a virtual classroom environment in which responses are automatically graded.

Worksheet Rendering

As discussed above, the process of rendering a worksheet processes the worksheet in a specific format and suitable for a specific delivery model. By separating the process of rendering from generation, we have the option of rendering the same worksheet in any number of formats and delivery models.

The format may be a static format like HTML, PDF, or an XML based format. The delivery model involves a dynamic component that controls how the worksheet is presented to the student and how the student interacts with it. The same format may be made suitable for several different delivery models. A set of HTML files can be created as a package where the only thing the student can do is view the questions. Alternatively, a set of HTML pages can be created in such a way as to invoke servlets to record an answer, move to the next question, measure the time since the last answer, and perform various other processing tasks.

Worksheet rendering can be performed on worksheets either generated from the dynamic templated abstract worksheets by the process described above or directly created by teachers by the process described below.

Various renderers are provided in various embodiments. The renderer includes the servlet that generates static questions in a specific format as well as the dynamic portion which implements the delivery model. Various examples of renderers are described below in Table 12.

TABLE 12
Various renderers

| | |
|---|---|
| PDF | The PDF renderer processes all the questions in a variable |
| renderer | number of columns in a test. The renderer can be |
| | configured to generate multiple-choice questions or questions |
| | without answer choices. The renderer also produces a |
| | separate answer sheet that lists the correct answers. In the |
| | case of multiple choice questions, the answers only |
| | provide the correct choice. |
| HTML | The HTML renderer produces a set of HTML tests that may be |
| renderer | responded to online from a web browser. The renderer can be |
| | configured in the following ways: Present multiple answer |
| | choices or not; vary the number of questions per page; allow |
| | or disallow answer changes; allow or disallow unanswered |
| | questions. The question batches are produced as HTML pages. |
| | By clicking buttons in the HTML mode the student is able to |
| | move between pages of the worksheet and answer the question. |
| | When moving to a page that has already been attempted, there |
| | may be indication to that effect, and the current response may |
| | be displayed. The answers are uploaded when moving between |
| | these pages. The questions are automatically graded when |
| | submitted if the answer is multiple choice answer. Surrounding |
| | servlets allow the teacher to grade the answers and allow |
| | students or parents to view the graded results. |
| XML | The XML renderer is suitable for, e.g., touch based tablet |
| based | devices. Electronic handwritten input has been discussed |
| renderer | above in various contexts. A self-contained XML file may |
| | be generated, which file is presented to the student via the |
| | student module 140. |

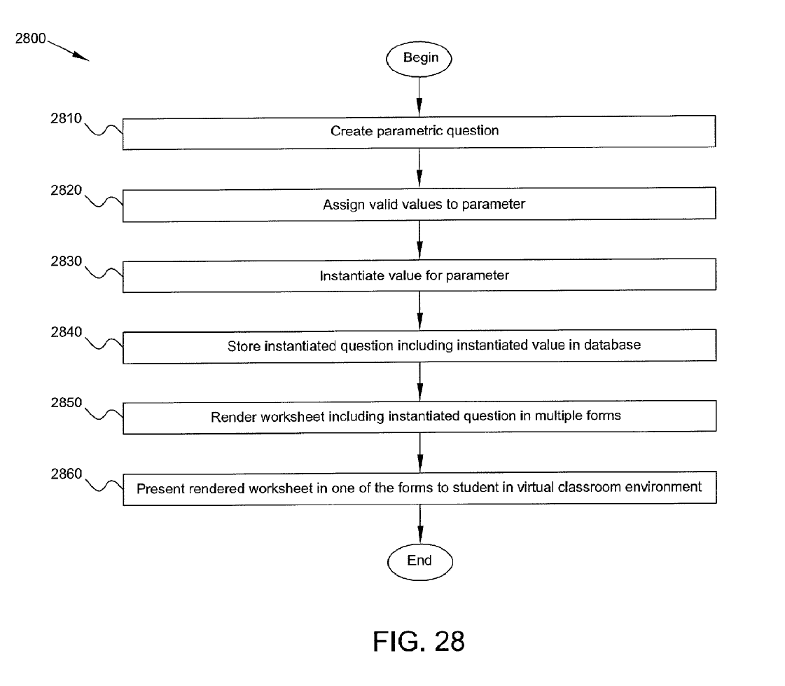

FIG. 28 is a flow diagram of a process involving instantiating and rendering information associated with a worksheet in accordance with some embodiments. After process 2800 begins, a parametric test question including multiple parameters is created at 2810. Valid values are assigned to at least one of the parameters at 2820. One of the valid values for at least one of the parameters is instantiated at 2830. An instantiated question including the instantiated value is stored in a database at 2840. A worksheet including the instantiated question is rendered in multiple forms at 2850. The rendered worksheet is presented in one of the forms to a student in a virtual classroom environment at 2860.

Manual Worksheet Creation

Worksheets may be created manually as well as automatically generated. When the worksheets are manually created, the creator provides the questions to the application module 130. This can be accomplished in a variety of ways. In particular, educators can manually create worksheets or they can markup PDF or other electronic files to indicate where the questions and answers are.

Marking Up the Source Content

Source content (e.g., an electronic book in a format such as PDF, e-Book, HTML, Microsoft Word, ePUB) may be manually marked up to indicate the worksheets and questions in the book for use in a virtual classroom environment. Exploitation of traditional electronic books in a new way in a virtual testing environment increases the options and resources available to teachers and students for learning. Existing books may be leveraged to provide testing and/or studying functionality.

Various components of a worksheet in a virtual classroom environment, e.g., reference page(s), sample page(s) or sample question(s), questions, answer choices, correct answers, etc. may be manually selected by the user (with reference to source content) or may be identified ahead of time in the document by inserting the XML-like tags in the document as discussed further below.

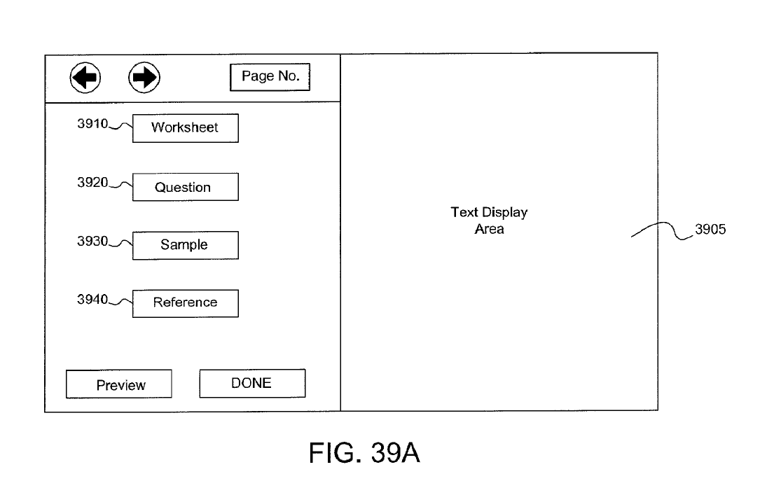

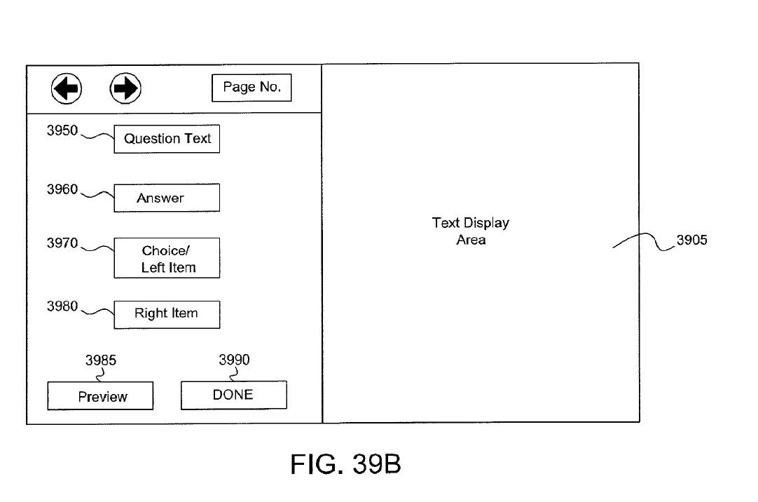

Manual selection may be performed using software that provides a display similar to that depicted in FIGS. 39A-B. The user may first mark the worksheets in the electronic book. The content of the electronic book is displayed in a text display area 3905. A worksheet button 3910 is used to select a worksheet. When the user selects a worksheet, he/she is prompted to enter the following information: name of the worksheet; worksheet number if it is not to be automatically generated; whether the worksheet is a question bank (where questions are delivered randomly without timing); whether the worksheet is one in which questions are delivered in order with timing but timing is not enforced; whether the worksheet is a quiz (where timing is enforced and samples or other content cannot be viewed before the end of the quiz); the time allotted, if the worksheet needs to be timed; and other worksheet-level properties.

The user can highlight a section of content in the text display area 3905 and click the worksheet button 3910 to mark that area as the worksheet or click on the worksheet button 3910 and then select the region or select the “start” and “end” points in the book.

After marking the worksheet, the user is prompted to mark the questions in the worksheet. As with the worksheet the user may mark the question with the question button 3920. Then the user is prompted to enter the following: the question number if it is not to be automatically generated; the type of question (e.g., short answer, automatically graded multiple choice, match the following, non-graded, etc.); the points or score allotted for this question (if the worksheet is not a question bank; all questions can accommodate partial scoring by the teacher based on answers provided); the question type (used for identifying the sample for this question); and other question-level properties.

The user may then mark the following items in the document related to the question: the detailed solution of the answer if that is available in the book; references (e.g., reference questions or reference text) and samples if available in the book (using reference button 3940 and sample button 3930); the answer choices if this is a multiple choice question; the short answer to match if this is a short answer question (using answer button 3960); the left side and right side values if this is a match the following question (using left item button 3970 and right item button 3980). The question text may also be specified using question text button 3950.

The worksheet may be previewed with the preview button 3985. When the DONE button 3990 is selected on the Worksheet screen, the entire created worksheet is uploaded to the application module 130. After creating the worksheet a user may modify the created worksheet, e.g., to add external links for samples, etc.

Known electronic textbook technologies do not allow publishers of electronic content to convert their content into a digital format with which users can interact with electronically. As an example, if a publisher of a test preparation book wants to convert the source content to a digital format, all that can be accomplished with conventional technology is to make the source content readable in any digital medium, but users cannot interact with the content. So, if there is a question in an algebra e-textbook with multiple choice answers provided, a typical user of a conventional system can only print the page and write the answer on a printed, paper, but cannot click or highlight or handwrite any response that can be graded automatically by the digital medium. This limited capability available in conventional systems may be referred to as “passive digitization.”

In various embodiments, a content owner or administrator converts electronic or non-electronic content into a digitized format with which users can readily interact and get responses back from the digital medium. This enhanced capability may be referred to as “active digitization.” Electronic source content that is initially “flat” or static and amenable only to being read is transformed by a markup process into dynamic content with an embedded superstructure that enables interactivity, e.g., in a virtual testing infrastructure. In some embodiments, non-electronic content may be similarly processed after an initial stage of conversion to electronic content (e.g., via scanning) and optical character recognition. In other embodiments, non-electronic content may be processed without optical character recognition, as the question, answer, and related non-electronic source material may be used, e.g., as images cut and pasted from a traditional non-electronic book or other document.

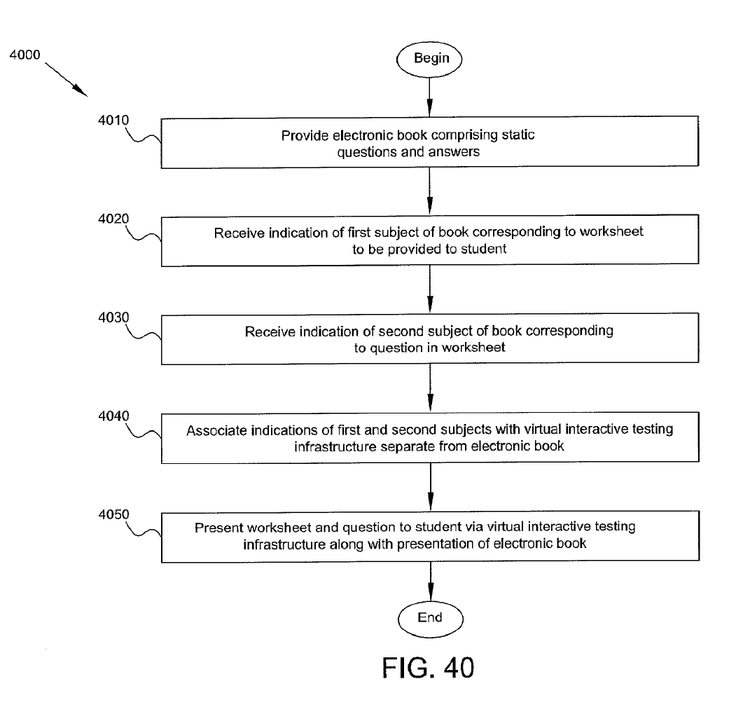

FIG. 40 is a flow diagram of a process involving active digitization of external source content in accordance with some embodiments. After process 4000 begins, an electronic book comprising static questions and answers is provided at 4010. As discussed above, the book that is actively digitized may be a traditional, non-electronic book in other embodiments. The questions and answers in the electronic book are static in the sense that they do not provide interactivity and may only be read. An indication of a first subset of the book corresponding to a worksheet to be provided to a student is received at 4020. An indication of a second subset of the book corresponding to a question in the worksheet is received at 4030. Multiple worksheets and/or questions may be marked up in this way in some embodiments. The indications of the first and second subsets are associated at 4040 with a virtual interactive testing infrastructure separate from the electronic book. The virtual interactive testing infrastructure may include components of the information sharing system 100. The worksheet and question are presented to a student via the virtual interactive testing infrastructure along with presentation of the electronic hook at 4050. Thus, the student may read the electronic book and engage in interactive testing inline, i.e., directly from the electronic book.

In some embodiments, the worksheets are created by marking up the electronic book with tags as described below. <WORKSHEET> and </WORKSHEET> tags identify the start and end, respectively, of the worksheet. Optionally, <WSID> and </WM> tags identify the question number and are unique within the worksheet. <QUESTION> and </QUESTION> tags identify the start and end of a question. Optionally, <QID> and <QID> tags identify the question number and are unique within the worksheet, <QUESTIONTEXT and </QUESTIONTEXT> identify the start and end, respectively, of the question portion of an answer within the question. Optionally, <QUESTIONTYPE> (with termination) is inserted to identify the question type which is used to identify the sample for the question. <ANSWER> and </ANSWER> identify the start and end, respectively, of the detailed solution (e.g., worked out with intermediate steps) to a question. This can be inside the question tag if the question and answer are located in the same place in the document, or it can be at a later point.

An <ANSWERTYPE> tag (with termination) is optionally inserted to identify the type of answer, which can be one of short-answer, multiple-choice, match-the-following, or other (not auto graded). If the answer type is short-answer, the <SHORTANSWER> and </SHORTANSWER> tags identify the start and end, respectively of the short answer to the question which will be matched against the answer provided by the responder. If the answer type is multiple-choice, <CHOICEn> and <CHOICEn> identify the start and end, respectively, of the n^{th} choice. If the current choice is the correct choice, a further parameter <CHOICEn CORRECT=true> is used. If the answer type is match-the-following then the tags <LEFTFIELDn MATCH=m> and <LEFTFIELDn> identify the start and end, respectively, of the nth left field. The MATCH=m parameter identifies the matching right hand side field. Similarly, the <RIGHTFIELDm> tag lists the right hand side fields. <REFERENCE> and </REFERENCE> tags identify the start and end, respectively, of the reference page. Subsequent questions until the next reference are by default associated with this reference page. <SAMPLE> and <SAMPLE> identify the start and end, respectively of the sample.

An external process may process the electronic book and create the required worksheets in the application module 130. After creating the worksheet the created worksheet may be modified. In particular, association of a sample with questions, question types or worksheets may be performed during this phase.

Answering Questions in the Electronic Book

In some embodiments, an electronic book is modified to add information that allows for a virtual classroom environment (e.g., with test question) to be superimposed upon the source content of the book. In this manner, a student may read the content of the book and answer questions and complete worksheets directly within the book. The information relating to the worksheets in the book are primarily stored in the application module 130. Minimal information to assist in porting the data onto the application module are be stored along with the electronic book. Depending on the format of the book this information may be stored inline or external to the book in local data storage. For example, in the case of ePUB books, the ePUB format provides the ability to capture such information inline without making it unviewable with other viewers. In the case of other formats, the information may be stored externally. The information stored may include the following: the location of different elements (worksheets, questions, reference passages, samples, elements within the questions, answers etc.); names (i.e., the text to display) for these elements when displaying them in the book; the ID for these elements with as identified in the database 120. Our modified book that is rendered takes this information and adds actionable buttons to the book. Clicking these buttons launches external software applications to answer the questions. The actual interface to answer the questions may be similar to the student module interface described previously above.

Samples

Samples are added by the creator of the worksheet. In the case of dynamically generated worksheets, these are pre-assigned in the system 100. In the case of a created worksheet, these are also added by the creator of the worksheet. After the creation of the worksheet, samples can be added by any teacher or student.

A sample can be associated with a single question, a question type (i.e. a templated question in the case of automatically generated worksheets), a specific group of questions created by the worksheet creator, or a worksheet. Once associated, the sample will be available for students attempting that question, question of that type or question in that worksheet.

A sample is essentially treated as a URL to some contents that can be displayed by a browser. Even when a creator wishes to provide the actual contents (as opposed to a link to one), this will be stored in a sample store area and only a link is stored in the database 120. The following attributes are tracked for a sample: the content originator (e.g., a teacher, student, or a commercial content vendor); whether the sample is free or paid content, and if paid, the rate plan; whether the sample is downloadable or not, i.e., whether the sample can be pre-downloaded when a worksheet is downloaded by a student; the learning style this sample uses; teacher recommendations, if any, i.e., whether a teacher specifically recommends this sample for a specific worksheet

For each student viewing a sample, the following data are tracked: the number of times different students view a specific sample for a specific problem; the number of times a specific student views a sample from the specific sample provider; the number of times the students at large view samples from this provider; ratings for this specific sample and samples from this provider. Based on all the above data, samples can be sorted to predict the suitability for presenting a specific problem to a specific student.

Implementation details of various system components are described below.

Interface with Application Module

The component description above described the communication requests supported. These are invoked over standard HTTP. Transfer of various requests and responses were described earlier under the application module section. Transfer of worksheets is described below.

Worksheet Transfer

As described earlier, worksheets may be rendered in multiple formats. One of the formats supported is the self-contained XML format which encapsulates the worksheet. The XML format can capture an unanswered worksheet as well as an answered and graded one. The tags of this XML format are described below.

TABLE 13
Description of keys associated with worksheets

| | | | |
|---|---|---|---|
| | | Values | |
| S. No | Key | (examples) | Description |

The following section is used for general information about Graded
worksheet

| | | | |
|---|---|---|---|
| | Worksheet | | Top tag which contains all the |
| | | | other tags below. |
| 1 | QuestionPaper | Sample_1 | Name of the worksheet |
| 2 | TimeDuration | 20 | Suggested time (minutes) to |
| | | | complete the worksheet |
| 3 | FilesRequired | Sample.htm, | The required files for the |
| | | sample.png | worksheet |
| 4 | Question | | Tag for each question in the |
| | | | worksheet. Contains the tags |
| | | | below with two digit |
| | | | numbering. |
| 4.1 | QuestionNo | 1 | Question no |
| 4.2 | Type | 2DigitAddition | Question Type |
| 4.3 | Description | 20 | Question description |
| 4.4 | Text | 30-2 | Question text. Either this or |
| | | | the link would be present. Not |
| | | | both. |
| 4.5 | Link | URL | Link to the URL for the |
| | | | question. One of Text or Link. |
| 4.6 | CorrectAnswer | 28 | Correct answer for question. |
| | | | If this was a multi-choice |
| | | | answer, this will just contain |
| | | | the letter identifying the |
| | | | choice. |
| 4.7 | AnswerType | Digital or | Indicates the type of interface |
| | | MultiChoice or | to be provided for answer |
| | | None | selection. |
| 4.8 | AnswerChoices | | A list of answer choices. Only |
| | | | of the AnswerType is |
| | | | MultiChoice. |
| 4.9 | Samples | | Holder for all the samples |
| | | | possible for this question. |
| | | | Wiil also include details |
| | | | about free vs. commercial, |
| | | | downloadable etc. |
| 4.10 | Reference | URL | Link to the reference page. |
| 4.11 | StudentAnswer | 27 | Student answer for this |
| | | | question |
| 4.12 | StudentImage | Test.png | Student image for this |
| | | | question |
| 4.13 | AutoCorrection | Y or N | Auto correction status |
| 4.14 | CorrectionStatus | Y or N | Correction status |
| 4.15 | TeacherImage | Test.png | The teacher grading response |
| | | | image. |
| 4.16 | AutoCorrection | N or Y | Y means answer is correct. N |
| | | | means - Answer is referred to |
| | | | teacher |
| 4.17 | AudioDoubt | Test.wav | If audio is recorded by |
| | | | student, audio file name will |
| | | | be the value of this field |
| 4.18 | AudioResponse | Test2.wav | This is the audio response |
| | | | recorded by the teacher if |
| | | | present. |
| 4.19 | TimeTaken | | Time taken for single question |
| 4.20 | PenResponse | | This is the pen response |
| 5 | AssignedDate | 2009-06-01 | Assigned date of worksheet |
| 6 | SubmittedDate | 2009-06-01 | Submitted date of worksheet |
| 7 | GradedDate | 2009-06-01 | Graded date of worksheet |
| 8 | StartTime | 2009/08/05 | Start time of worksheet taken |
| | | 12:21:49 | by student |
| 9 | EndTime | 2009/08/05 | End time |
| | | 12:41:49 | |
| 10 | Score | 90 | Total score (%) for this |
| | | | worksheet |
| 11 | ScoreDescription | Excellent | Score Description |
| 12 | ScoreGrade | A | Score grade. It will be A+, A, |
| | | | B, C, D, E. |
| 13 | ScoreCompetency | Proficient in | Competency rating for this |
| | | sample | worksheet |
| | | worksheet | |

An example assigned worksheet with XML tags is presented below.

```
<Worksheet>
  <QuestionPaper> Sample_1</QuestionPaper>
  <TimeDuration>20</TimeDuration>
  <FilesRequired>Sample.htm,Sample.png</FilesRequired>
  <Question>
    <QuestionNo>1 <QuestionNo>
    <Type> 2DigitAddition </Type>
    <Description>Add the following</Description>
    <Text>20 + 10 = ? </Text>
    <Link>SampleProblem.htm</Link>
    <CorrectAnswer>30</CorrectAnswer>
    <AnswerType>1</AnswerType>
    <Samples>
  http://samplepage.com/sample.htm:free;http://samplepageone/
  sample.jpg:download</Samples>
    <Reference>http://prazas.com/ReferencePage.htm</Reference>
  </Question>
  <Question>
    <QuestionNo>1 <QuestionNo>
    <Type> 2DigitSubtractiontion </Type>
    <Description>Subtract the following</Description>
    <Text>20 − 10 = ? </Text>
    <Link>SampleProblem.htm</Link>
    <CorrectAnswer>10</CorrectAnswer>
    <AnswerType>1</AnswerType>
    <AnswerChoices>
      <Choice1> 30 </Choice1>
      <Choice1> 32 </Choice1>
      <Choice1> 15 </Choice1>
      <Choice1> 10 </Choice1>
    </AnswerChoices>
    <Samples>
  http://samplepage.com/sample.htm:free;http://samplepageone/
  sample.jpg:download</Samples>
    <Reference>http://prazas.com/ReferencePage.htm</Reference>
  </Question>
</Worksheet>
```

An example submitted worksheet is presented below.

```
<Worksheet>
  <QuestionPaper> Sample_1</QuestionPaper>
  <TimeDuration>20</TimeDuration>
  <TimeTaken>4<TimeTaken>
  <FilesRequired>Sample.htm,Sample.png<FilesRequired>
  <Question>
    <QuestionNo>1 <QuestionNo>
    <Type> 2DigitAddition </Type>
    <Description>Add the following</Deseription>
    <Text>20 + 10 = ? </Text>
    <CorrectAnswer>30</CorrectAnswer>
    <AnswerType>1</AnswerType>
    <StudentAnswer> 30</StudentAnswer>
    <StudentImage> sample_1_1.png </StudentImage>
    <AutoCorrection> Y </AutoCorrection>
    <TimeTaken> 130:25:15:45</TimeTaken>
    <AudioDoubt> test.wav</AudioDoubt>
  </Question>
  <Question>
    <QuestionNo>2 <QuestionNo>
    <Type> 2DigitSubtractiontion </Type>
    <Description>Subtract the following</Description>
    <Text>20 − 10 = ? </Text>
    <Link>SampleProblem.htm</Link>
    <AutoCorrectionAvailable>Y</ AutoCorrectionAvailable>
    <CorrectAnswer>10</CorrectAnswer>
    <AnswefType>2</AnswerType>
    <AnswerChoices>
      <Choice1> 30 </Choice1>
      <Choice1> 32 </Choice1>
      <Choice1> 15 </Choice1>
      <Choice1> 10 </Choice1>
    </AnswerChoices>
    <Samples>
  http://samplepage.com/sample.htm:free;http://samplepageone/
  sample.jpg:download</Samples
    <Reference>http://prazas.com/ReferencePage.htm</Reference>
    <StudentAnswer> 10</StudentAnswer>
    <StudentImage> sample_1_2.png </StudentImage>
    <AutoCorrection> Y </AutoCorrection>
    <TimeTaken> 110:20:15:35</TimeTaken>
  </Question>
</Worksheet>
```

An example graded worksheet is presented below.

```
<Worksheet>
  <QuestionPaper> Sample_1</QuestionPaper>
  <TimeDuration> 20 </TimeDuration>
  <TimeTaken> 4 <TimeTaken>
  <FilesRequired>Sample.htm,Sample.png</FilesRequired>
  <AssignedDate> 10-Aug-09</AssignedDate>
  <SubmittedDate> 10-Aug-09</SubmittedDate>
  <GradedDate> 11-Aug-09</GradedDate>
  <Score> 100 </Score>
  <ScoreDescription> Excellent </ ScoreDescription>
  <ScoreGrade> A+</ ScoreGrade>
  <ScoreCompetency> Excellent in Proficiency in Sample
  </ ScoreCompetency>
  <Question>
    <QuestionNo>1 <QuestionNo>
    <Type> 2DigitAddition </Type>
    <Description>Add the following</Description>
    <Text>20 + 10 = ? </Text>
    <CorrectAnswer>30</CorrectAnswer>
    <StudentAnswer> 30</StudentAnswer>
    <StudentImage> sample_1_1.png <StudentImage>
    <CorrectionStatus> Y </CorrectionStatus>
    <AudioResponse> test.wav</AudioResponse>
  </Question>
  <Question>
    <QucstionNo>2 <QuestionNo>
    <Type> 2DigitSubtractiontion </Type>
    <Description>Subtract the following</Description>
    <Text>20 − 10 = ? </Text>
    <CorrectAnswer>10</CorrectAnswer>
    <StudentAnswer> 20</StudentAnswer>
    <StudentImage> sample_1_2.png </StudentImage>
    <PenResponse>Y</PenResponse>
  </Question>
</Worksheet>
```

Sharing Protocol (Between a Pair of Student/Teacher Modules)

The session establishment and transport for the communication protocol is provided either by a sharing module 150 or direct peer-to-peer connection. A session may be initiated by one participant towards another participant. The participant receiving the request has the option to accept or reject the request. When the initiator is a teacher and the recipient is a student, the teacher has the option of requesting the connection.

Once the transport is established, the protocol functions as follows. Each message exchanged has the following format. Specific field lengths provided below are only in some embodiments and are non-limiting. A type field having 2 bytes specifies the type of the message. A length field having 2 bytes specifies the length of the value field of the message and has a value less than or equal to 65536. A value field having a variable length contains the contents of the message and has a structure determined by the type of the message. This message format enables easy version control. Messages whose type are not understood or are “don't care” messages may be skipped. The messages exchanged by the various modules are specified below.

Scribble Data

Scribble data is sent from one module to another. The data identifies the color of the scribble, the line style, the number of points and the points themselves. It also identifies the tab to which a scribble should be associated. In some embodiments, “erase” is considered as a special color. Scribble data is described in Table 14.

TABLE 14
Scribble data

| Type | Length | Value |
|---|---|---|
| 19 | 1 byte + 1 byte + (number of | Scribble color, stroke, points, |
| | scribble points * 4 bytes) + | (Student ID or Teacher ID), Tab |
| | 4 bytes + 4 bytes | Number |

New Question Data & Question Upload

This provides the question text or URL. This also identifies the tab to which the question is associated. If the question is a URL it may be rendered in the background layer. The scribbles are on a higher layer. New question data is described in Table 15.

TABLE 15
New question data

| Type | Length | Value |
|---|---|---|
| 21 | 64 bytes + 4 bytes | Question Data + Tab Number |

Whiteboard Clear Request from Teacher or Student

A whiteboard clear request clears the virtual whiteboard for parties sharing a whiteboard. This message is described in Table 16.

TABLE 16
Whiteboard clear request

| Type | Length | Value |
|---|---|---|
| 24 | 4 bytes | Teacher ID or Student ID |

Request to Change from Stealth to Normal Mode

When the teacher is already in a collaboration session with the student in the stealth, this requests the other side to switch to normal mode. This request may be initiated by the teacher who wishes to announce his/her presence or by the student who unknowingly also wishes a session with the teacher. This message is described in Table 17.

TABLE 17
Request to change from stealth mode to normal mode

| Type | Length | Value |
|---|---|---|
| 27 | 0 byte | |

New Tab Added

A new page/tab has been added to the whiteboard. This message is described in Table 18.

TABLE 18
New tab added message

| Type | Length | Value |
|---|---|---|
| 29 | 0 byte | |

Closed Tab

One of the tabs has been closed by one of the shared whiteboard participants. This message is described in Table 19.

TABLE 19
Closed tab

| Type | Length | Value |
|---|---|---|
| 31 | 4 bytes | Closed Tab Number |

Layer Manipulation

Additional messages support Layer manipulation include the following: Layer creation (type 35), Layer deletion (type 36), Layer move (type37), .Make Layer a page (type 38), Change Layer Permissions (type 39). During Layer creation and while changing layer permissions, the list of users (subset of the users in the collaboration) who can edit the layer is identified. Only the layer creator can perform the other operations.

Additionally other messages may also optionally take a layer parameter including Scribble Data (type 19). New Question Data (type 21), and Whiteboard Clear request (type 24).

Notetaking Tool

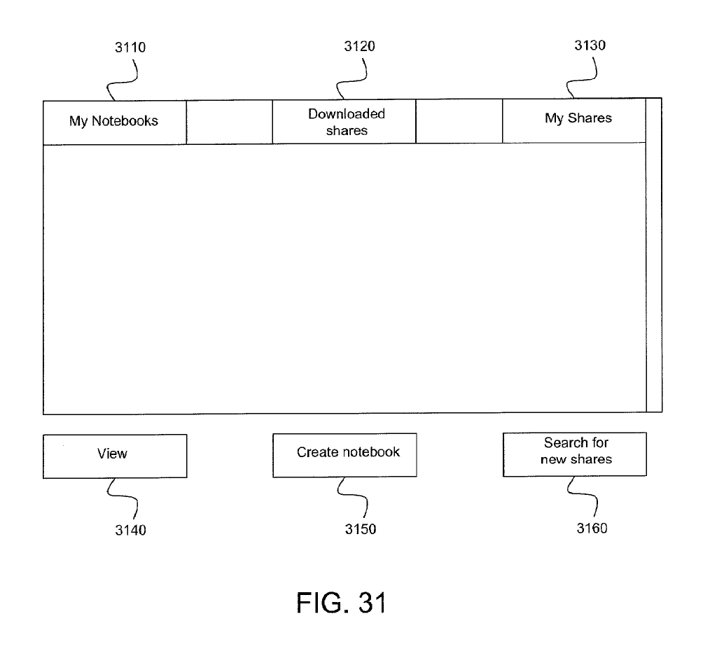

Some embodiments provide notetaking functionality that builds on multimedia and layering concepts described above. FIG. 31 is a depiction of a sample display for a notetaking application. A notebooks tab 3110, a downloaded shares tab 3120, and a My Shares tab 3130 are shown. The notebooks tab 3110 displays a list of a user's notebooks. Notebooks are displayed in this view with the name, the date created, date last modified, course, and number of pages. The downloaded shares tab 3120 displays downloaded notebooks of other users. The author who created each notebook, and the name, course and the number of pages in each notebook may be displayed in this view. The My Shares tab 3130 displays the notebooks shared by this user. The notebook name, the date of sharing, the pages shared and whether the share is a public or private share may be displayed in this view.

The user may select any notebook and click the view button 3140 to cause the notebook to be displayed in view mode, which is described further below. A newly created notebook is opened in scribble mode, which is described further below. This will launch the notebook view in a separate window. The create notebook button 3150 is used to create a new notebook. The user specifies a course name, notebook name and keywords to create a new notebook. The user may search for new shared notebooks using button 3160. Users may search shares by course, notebook keywords, date range, user name, or most recent N shares (N is some numeric value). This launches the search view in a separate window. When the My Shares tab 3130 is active, the delete button 3170 and Change Share Tag button 3180 are displayed. A user who wants to stop sharing an already shared notebook may select that notebook and click the delete button 3170 to stop the sharing. If the other user already downloaded this particular share, this downloaded share cannot be removed from the other user's local disk in some embodiments. If a user wants to change a privately shared notebook to public or a publicly shared notebook to private, he/she may select the notebook and click button 3180. If the selected notebook is privately shared and the user clicks this button, the notebook share is changed to public share. If the user selected notebook is publicly shared and the user clicks this button, then a user list is opened here, and user may select the user list and click a submit button to change the share to private share.

The notetaking application has five modes: scribble mode, text mode, background mode, view mode, and play mode.

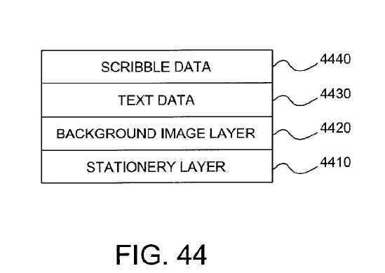

As shown in FIG. 44, the notetaking application may have 4 layers in the following order: stationery layer 4410 (bottom layer); optional background image layer 4420 (between stationery layer 4410 and text data 4430; contains any background images); optional text data layer 4430 (contains any typed text); scribble data layer 4440 (top layer which contains user-drawn scribbles). When viewing the notebook, the actual notebook size may be larger than the screen size. Vertical and horizontal scrollbars may be provided as required to move all the above four layers 4410, 4420, 4430, and 4440 together.

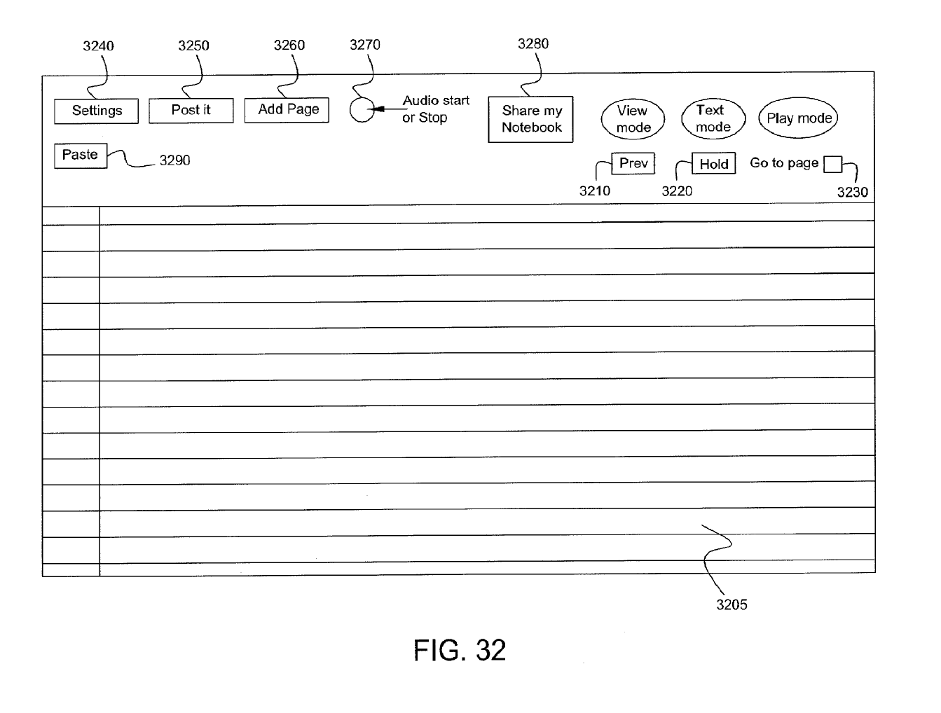

Referring to FIG. 32, common buttons for all modes are a Prey button 3210 to go to the previous page of notes, a Next button 3220 to go to the next page, a Go to page button 3230, and a settings button 3240. Settings that may be configured include the following: stationery type (e.g., ruled, unruled), size and color of the page, size and color of the floating notes, name of the notebook, user ID, password and server URL for sharing. The user may upload different types of stationery of other background content to a background (base) layer in some embodiments.

Scribble Mode

If the user opens a new notebook, the notebook opens in scribble mode. In this mode, if text is already available for the opened page that text is visible in the background. The user may scribble above the text in a scribble area 3205. The underlying text is a base layer of content as described previously above.

Clicking the floating note button 3250 causes a floating note (sticky note) to popup. The user may scribble onto the floating note, which is then saved into memory. The user may select a location for placing the floating note on the page, either by dragging an existing floating note or by clicking on a location for creating a new floating note. Once an edit to a floating note is completed, the floating note can be made to appear in full or minimized display mode at a particular location. The floating note may be moved to another location by clicking and dragging an icon representing the floating note or by dragging the full floating note. A minimized floating note may be double clicked to maximize it. A delete button may be selected to delete the StickyNote from a particular location.

An add page button is used to add new pages to the notes document. In various embodiments, the new page may be added as a next or previous page or at the end of the current notes document.

An audio start or stop button is shown in FIG. 32. Initially, an audio start button is displayed on the screen. This button is used to start recording the audio with user started time. The user clicks this button, causing the button to change to a stop button. Once the user finishes recording the audio, the user clicks the stop button to save the recorded audio. A user may record any number of audio recordings per page.

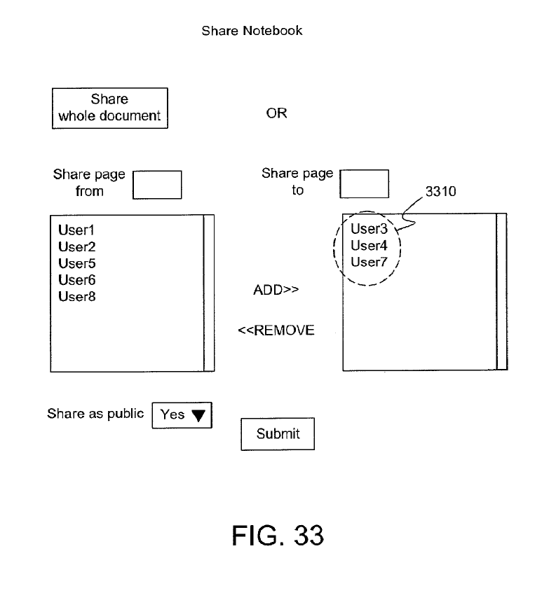

The Share My Notebook button 3280 is used to share the current notebook with others. A user can share an entire document or selected pages with others. FIG. 33 is a depiction of a sample display for sharing a notebook. A list of users 3310 to share the notebook with is entered by a user. If the user selects a “Share as public” option as ‘yes’ then the share is “public share.” In public share a UserList user interface (UI) will not be displayed on the screen. If the user selects the “Share as public” option as ‘no’ then the share is “private share”. In private share the UserList UI is displayed on the screen. The user may select the list of users from the UserList and click a submit button to share the notebook.

The paste button 3290 is only visible when the user clicked a copy page button previously to copy existing scribble data. The copied page is stored in memory. Once the user clicks the paste button 3290, the page is saved in the current notebook. Scribbles in this page can be erased since this is in the same layer that the user is editing (modifying).

Text Mode

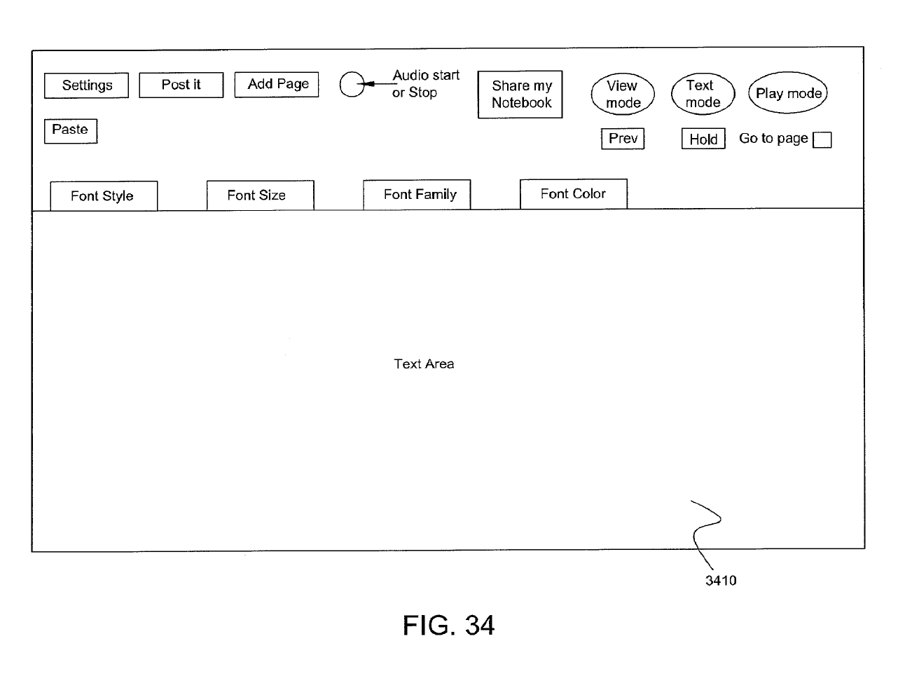

The text mode, a sample display of which is depicted in FIG. 34, is similar to the scribble mode except that the user inputs text (e.g., typed text) instead of handwritten scribbles to provide notes. Text may be entered in a text area 3410.

Background Edit Mode

In background edit mode, underlying stationery (e.g., ruled or unruled paper) is shown. On this stationery the user may paste and manipulate background images and/or other objects, which may overlap each other. Background images and objects may be resized, rotated, moved, or pushed towards the front or back. In some embodiments, information may be layered even within the background image layer, i.e., the background image layer may itself comprise multiple layers.

In background edit mode, left clicking (i.e., clicking a left mouse button) and dragging may move an image or other object if the click is on the image/object. Otherwise, left clicking and dragging groups objects. Right clicking may show a menu with, the following options: rotate (display a wire frame 4505 to rotate the object); resize (display a wire frame to resize the object); .push backward (pushes the object one step backward in the Z order, i.e., in terms of layers); .bring forward (brings the object one step forward in the Z order); push to back (pushes the object all the way to the back in the Z order); bring to front (brings the object all the way to the front in the Z order); delete (deletes the object); group (groups objects together); ungroup (ungroups the objects in the selected group).

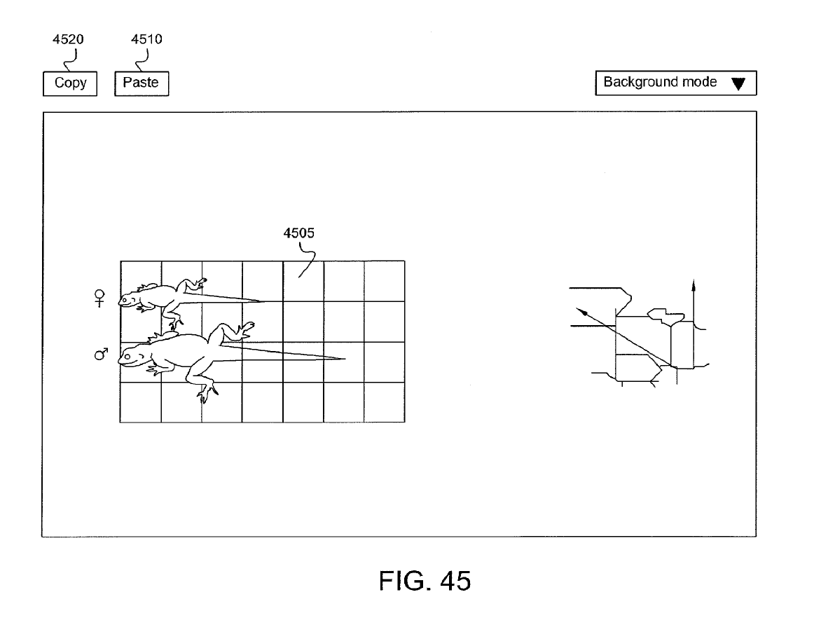

In the background edit mode, selecting the Paste button 4510 shown in FIG. 45 pastes any clipboard content copied from anywhere (e.g., a browser or document viewer/editor) as an image object. Selecting the copy button 4520 copies an image object or group of objects.

View Mode

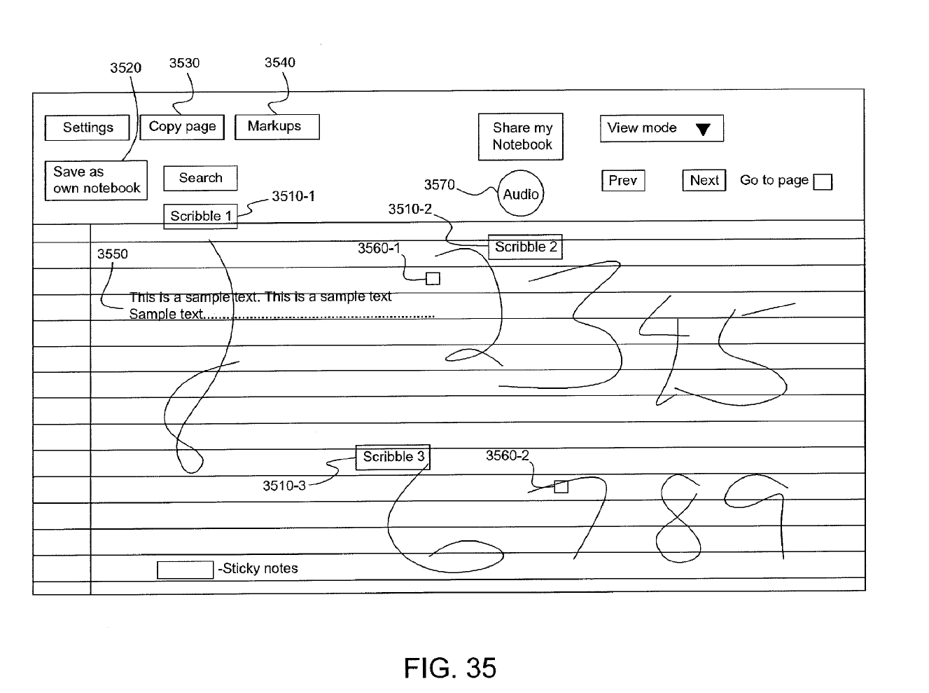

If the user opens an existing notebook, the page is displayed in view mode. The user cannot edit the page in this mode. FIG. 35 is a depiction of a sample display in view mode. Various scribbles are shown. Indications 3510-1, 3510-2, and 3510-3 are provided at locations corresponding to distinct scribble cluster. A scribble cluster (also referred to as scribble session) is a set of one or more scribbles that are automatically clustered together based on temporal proximity, e.g., by detecting a significant time gap between one scribble and the next and thus marking a new scribble cluster. A new scribble cluster may also be started when the user clicks in another window and then returns to the notetaking window or when the user closes the notetaking application and then reopens it.

The Save as own notebook button 3520 is displayed when the user is viewing another user's shared notebook. The user can click this button to save the other user's notebook as his/her own notebook. This will create a new notebook. The user provides the name of the notebook and has the option to modify the other details (e.g., keywords and course name).

The Copy page button 3530 is visible when the user is viewing another user's notebook. This button is used to copy the page. The copied page is stored in memory. If the user clicks the copy page button again, the formerly copied page is overwritten. The user may save this copied page via the paste option in view/scribble/text mode, described above.

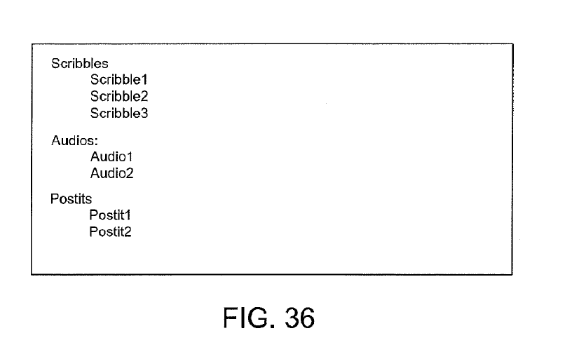

The markups button 3540 is used to view the page by markup view. This will show the Markup list as depicted in FIG. 36. In some embodiments, the user may click these markups to view or listen to the actual data.

Underlying text at a background layer 3550 is shown in FIG. 35. Thus, the user may scribble over existing text. Indications 3560-1 and 3560-2 show the locations of floating notes (sticky notes) on the page. An audio icon 3570 shows the presence of audio recordings among the recorded notes.

Play Mode

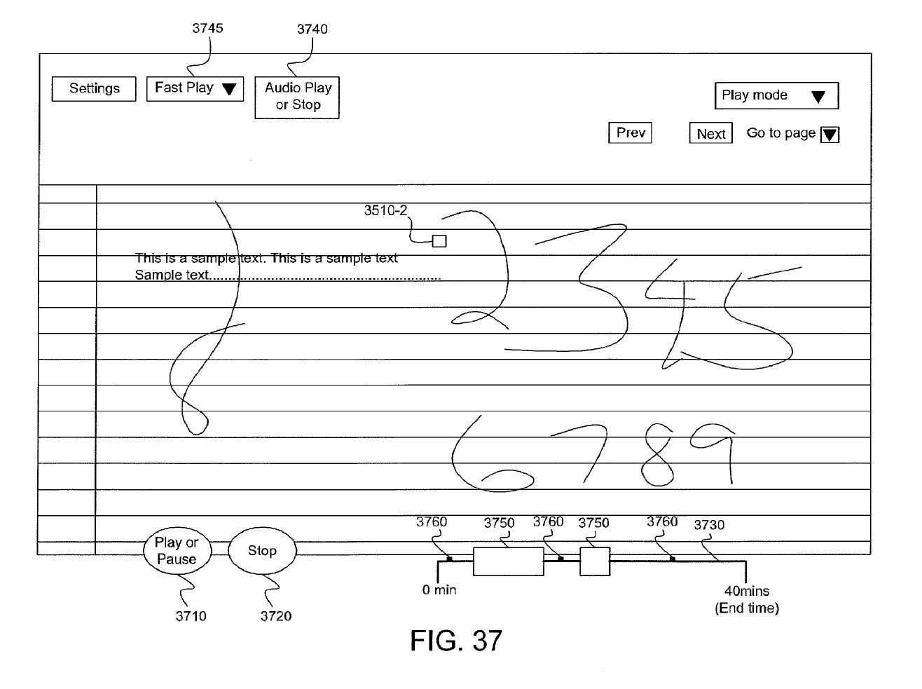

The play mode is used to play the notes page. At the start, the end state is shown, as in the depiction of FIG. 37. The play/pause button 3710 is used to play the recorded scribble and/or audio information from the starting of the page. When the play button 3710 is clicked, it changes to a pause button. Clicking the pause button causes play to stop. The play button is then shown.

Audio starts to play with the recorded start time, i.e., at a time corresponding to when the audio was recorded. In some embodiments, playback of scribbles and audio may occur at a rate faster than the original input rate, e.g., at twice (or another factor) the speed at which the notes were originally recorded, or at a rate slower than the original input rate. A fast play button 3745 may be selected to display a .popup menu with options for various speeds, e.g., 2×, 4×, 8×, 16×, etc. in the forward direction as well as in the reverse direction.

The stop button 3720 stops playback and displays the end state. Playback may be resumed from the start, by clicking play 3710, or by clicking near a scribble group, in which case all scribbles recorded prior to that scribble group are immediately displayed, and scribbles beginning with the selected scribble group are subsequently displayed in playback mode at a rate proportional to the rate at which they were originally provided as input.

In some embodiments, an audio play/pause button 3740 is used to play audio. Initially this button is an audio play button. When the user clicks this button, the button will change to stop button. If the user clicks the stop button, audio play will stop. This will only play the audio without playing the scribbles. If there are jumps in the audio, may be pause of some duration, e.g., 10 seconds, between each jump, An audio jump may correspond to a stop and start of a recording or a silence period of greater than a predetermined duration, e.g., 10 seconds.

The user can play scribbles using the slider bar 3730. Playback starts from the time the user selected by the user via the slider bar 3730. In some embodiments, the slider bar 3730 includes one or more indications 3750 of time interval(s) containing audio recording(s). The indication(s) 3750 may be provided in a predetermined color. The slider bar 3730 may also include an indication 3760, e.g., dot(s) of a predetermined color, of a change in scribble cluster.

The user may select a scribble or scribble cluster. The user may play scribbles beginning with the user selected scribble (or scribble cluster). The corresponding time (relative to the recording start time) may be displayed. Scribbles corresponding to times before the time of the user selected scribble (or scribble cluster) may displayed on the screen, and scribble playback may start from the selected scribble timeline. Playback of audio recordings may start from the time of the user selected scribble (or scribble cluster).

FIG. 41 is a flow diagram of a process involving note taking in accordance with some embodiments. After process 4100 starts, electronic input from a user is received over a first time interval at 4110. The electronic input is handwritten input or typed input. Audio input is received from the user at 4120 during a second time interval that may overlap the first time interval. In other words, the intersection of the first and second time intervals may be nonempty. The first and second time intervals may also be non-overlapping, e.g., in a case in which a user provides a scribble input and separately provides an audio input after the end of the scribble input. The electronic input and audio input are played back to the user over a third time interval at 4130. The third time interval may be different from the first and second time intervals, e.g., to allow the user to replay only a portion of recorded scribble or audio data or to replay a union of the time intervals. The third time interval may also be the same as the first or second time intervals.

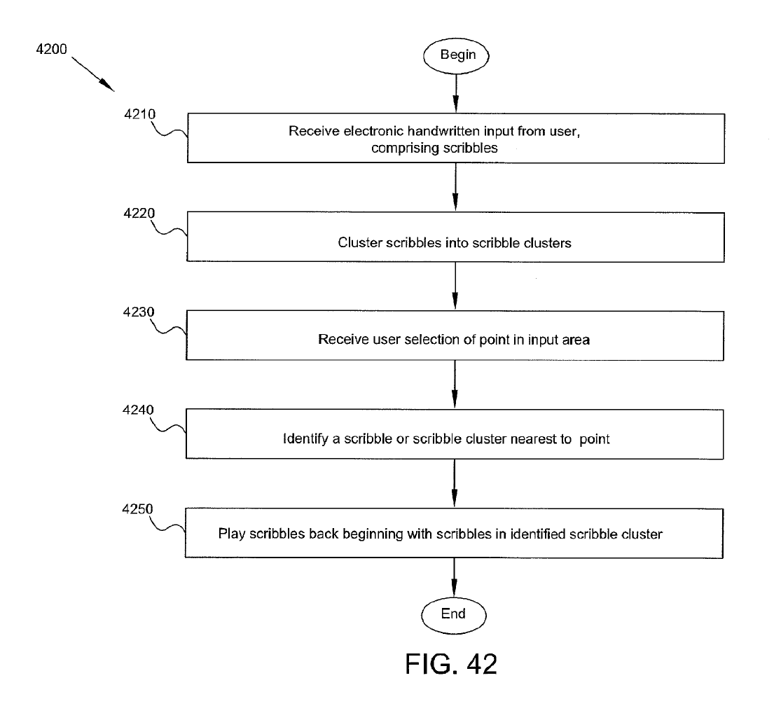

FIG. 42 is a flow diagram of a process involving playing back handwritten electronic input in accordance with some embodiments. After process 4200 begins, electronic handwritten input comprising a plurality of scribbles is received from a user at 4210. The scribbles are automatically clustered into scribble clusters at 4220. A user selection (indication) of a point in the input area in which the scribbles are inputted is received at 4230. A scribble or scribble cluster nearest to the point is identified at 4240. Scribbles are played back beginning with the scribble(s) in the identified scribble cluster at 4250. If there is no disruption in taking notes on a page, then the whole page may be a single scribble cluster. In that case, rather than identifying a nearest scribble cluster, a scribble nearest to a point that is selected (e.g., clicked) by the user may be identified.

In some embodiments, a computer readable storage medium as described further below has instructions stored thereon. The instructions when executed by a processor cause the processor to perform the operations of processes 4100 and/or 4200.

Search for Shared Notebooks

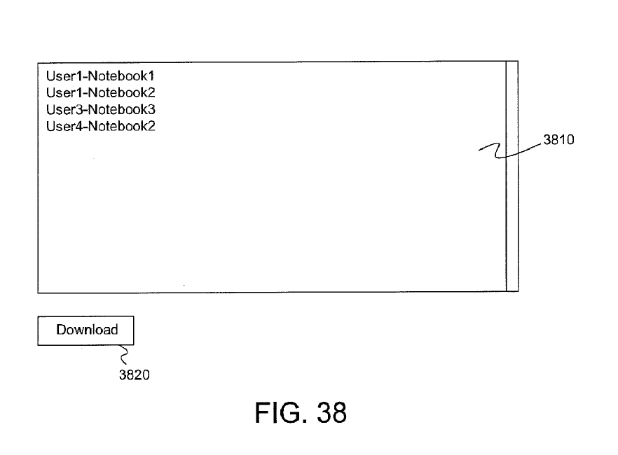

The user may search shared notebooks in various ways, e.g., by course, notebook keywords, date range, user name, or most recent N shares (where N is some numeric value. Search results may be displayed as in the depiction of FIG. 38. A list of notebooks of various users is provided in search results 3810. The user may select any notebook from the list and click the download button 3820 to cause the shared notebook to be downloaded into local data storage. This can be accessed from the downloaded shares tab once the download is complete.

Embodiments involving active digitization and notetaking may be combined with various features related to a virtual classroom environment as above to provide an integrated system that provides a testing infrastructure, mechanisms for adapting existing source content to the testing infrastructure, and mechanisms for users to take notes in various ways to augment their learning and/or collaboration activities. In some embodiments, notetaking functionality is provided separately from the context of a virtual classroom environment and provides a broad capability for users to mark up various types of electronic content with their notes in new ways, e.g., using layers as content protection mechanisms and using audio, handwritten electronic input, and/or typed or otherwise inputted digital text in an integrated fashion.

With both active digitization and notetaking as described above in the context of various embodiments, the lowest layer (stationery layer) in the notebook may comprise the pages of a hook (e.g., an electronic textbook in various formats such as PDF, ePUB, HTML etc.). Thus, in various embodiments notes may be recorded on an existing book.

Various embodiments may be used in contexts other than virtual classroom environments. In various contexts, people may collaborate with one another using embodiments. For example, doctors may interact with other doctors or patients to review diagnostic or research information involving patients. In corporate training environments, collaboration between employees is facilitated. Embodiments may be used as a tool for collaborations between vendors, suppliers, manufacturers, and end use customers for product demonstrations, training and other needs. Embodiments may be used as a tool for collaborative learning between teachers and students of music, including for the use of vocal and instrumental music. Embodiments may be used as a tool for collaborations between musicians for generating new songs or albums. Interactions with any digitized book are supported including, as an example, interactions with test preparation books with capabilities for intelligent assessments with timely and immediate feedback. Various embodiments provide a comprehensive learning management system (LMS), content management (CMS), and collaborative learning system.

Embodiments may be used in mobile and other electronic devices to deliver knowledge based content modules. As an example, embodiments deliver appropriate and timely information to doctors and lawyers and other professionals for receiving continuing education credits or for being informed about advances in their respective fields. Embodiments may be used as a pharmaceutical prescription management and delivery system. As an example, doctors can provide handwritten prescriptions that can be digitally delivered to pharmacists and patients.

As yet another example, embodiments may be used as an electronic medical record keeping database and delivery system to be used by doctor's offices, pharmacies, hospitals and patients. For example, all notes relating to a patient's image can be automatically saved and stored against patient records which can later be pulled down by other users within a participating network. In some embodiments, a user of a collaboration system is a provider of medical services, and the provider's electronic input comprises electronic notes related to a medical service rendered to a patient, including collection of the patient's medical and/or insurance information, handwritten notes taken during the patient's interaction with doctors and physicians, an audio recording of the doctors' assessment, as well as a doctor's interaction with the patient.

Example Description of Use as a Collaborative Tool for Doctors

Doctors can use a virtual collaboration tool as in various embodiments to stay informed of the latest developments in the field of medicine. Information may be delivered to such doctors the way virtual lessons are delivered to students in online learning environments. Doctors can also use the tool to interact with other doctors and patients to review scans of X-rays, CT scans, MRI scans and other images. As an example, this application can also be used by non-doctors to take pictures of patients' eyes in rural areas and transmitted to actual doctors to review the images, write comments on the images, and route them to other doctors or medical professionals.

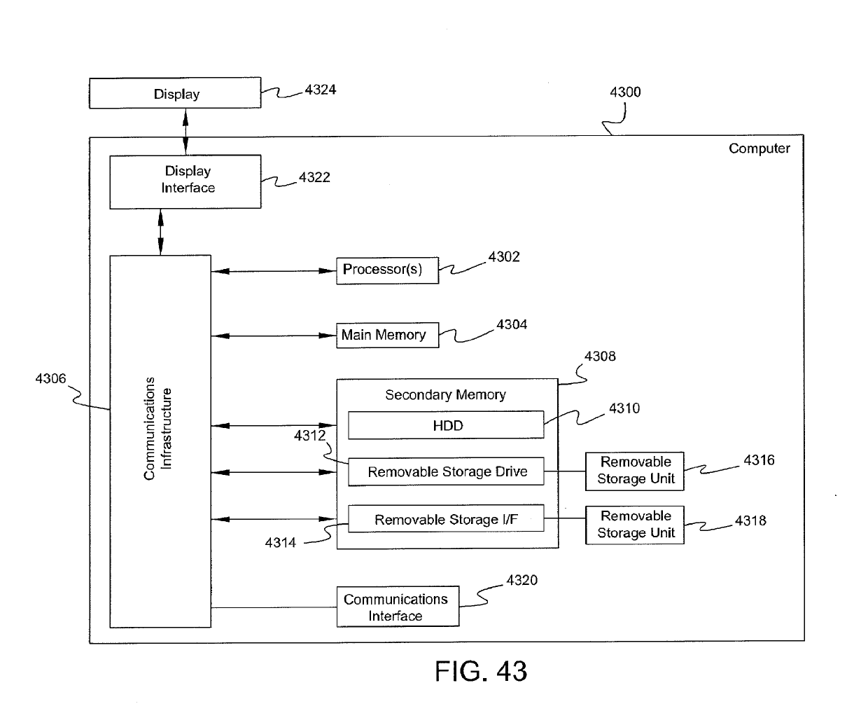

The subordinate module 140 and the supervisor module 160 may each include a software application executed by a processor on a computer, which may include a desktop or notebook computer, a tablet PC, a smartphone, personal digital assistant (PDA), multifunction device, or any other computing device. An example of such a computer system 4300 is shown in FIG. 43.

The subordinate module 140 and the supervisor module 160 may each be implemented in software and presented to a corresponding user on a monitor or other display device. In some embodiments, the subordinate module 140 and the supervisor module 160 may each be presented to a corresponding user as a graphical user interface (GUI) on a display device such as a computer monitor. As illustrated in FIG. 4, computer system 4300 may include one or more processors 402. The processor 402 is connected to a communication infrastructure 4306 (e.g., a communications bus, cross-over bar, or network). Computer system 4300 may include a display interface 4322 that forwards graphics, text, and other data from the communication infrastructure 406 (or from a frame buffer) for display on the display unit 4324.

Computer system 4300 also includes a main memory 404, such as a random access memory (RAM), and a secondary memory 4308. In some embodiments, only one type of memory is provided. The secondary memory 408 may include, for example, a hard disk drive (HDD) 4310 and/or removable storage drive 4312, which may represent a floppy disk drive, a magnetic tape drive, an optical disk drive, or the like. The removable storage drive 4312 reads from and/or writes to a removable storage unit 4316. Removable storage unit 4316 may be a floppy disk, magnetic tape, optical disk, or the like. As will be understood, the removable storage unit 4316 may include a computer readable storage medium having stored therein computer software and/or data.

In alternative embodiments, secondary memory 4308 may include other similar devices for allowing computer programs or other instructions to be loaded into computer system 4300. Secondary memory 4308 may include a removable storage unit 4318 and a corresponding interface 4314. Examples of such removable storage units include, but are not limited to, USB or flash drives, which allow software and data to be transferred from the removable storage unit 4318 to computer system 4300.

Computer system 4300 may also include a communications interface 4320. Communications interface 4320 allows software and data to be transferred between computer system 4300 and external devices. Examples of communications interface 4320 may include a modem, Ethernet card, wireless network card, a Personal Computer Memory Card International Association (PCMCIA) slot and card, or the like. Software and data transferred via communications interface 4320 may be in the form of signals, which may be electronic, electromagnetic, optical, or the like that are capable of being received by communications interface 4320. These signals may be provided to communications interface 4320 via a communications path (e.g., channel), which may be implemented using wire, cable, fiber optics, a telephone line, a cellular link, a radio frequency (RF) link and other communication channels.

As used herein, the terms “computer program medium” and “computer readable storage medium” refer to media such as removable storage drive 4312, or a hard disk installed in hard disk drive 4310. These computer program products provide software to computer system 4300. Computer programs (also referred to as computer control logic) are stored in main memory 4304 and/or secondary memory 4308. Computer programs may also be received via communications interface 4320. Such computer programs, e.g., in the form of software instructions, when executed by a processor, enable the computer system 4300 to perform the features of the method discussed herein. For example, main memory 404, secondary memory 408, or removable storage units 416 or 418 may be encoded with computer program code for performing the processes shown in FIGS. 3, 24, 26, 27, 28, 39, 40, 41, and 42.

In an embodiment implemented using software, the software may be stored in a computer program product and loaded into computer system 4300 using removable storage drive 4312, hard drive 4310, or communications interface 4320. The software, when executed by a processor 4302, causes the processor 4302 to perform the functions of the methods described herein. In other embodiments, corresponding methods may be implemented primarily in hardware using, for example, hardware components such as a digital signal processor comprising application specific integrated circuits (ASICs). In yet another embodiment, such a method is implemented using a combination of both hardware and software.

A user may interact with the subordinate module 140 or the supervisor module 160 via standard input functionality associated with the computer 4300, e.g., any form of electronic input (e.g., a mouse, a keyboard, clicking or otherwise selecting icons on a display, touch input on a tablet computer or smartphone, etc.

A user interface (UI), as used herein, comprises one or more display images, generated by processor such as processor 4302 and enabling user interaction with processor 4302 or other device(s) and associated data acquisition and processing functions.

The UI also includes an executable procedure or executable application. The executable procedure or executable application conditions the user interface processor to generate signals representing the UI display images. These signals are supplied to display 4324 which displays the image for viewing by the user. The executable procedure or executable application further receives signals from user input devices, such as a keyboard, mouse, light pen, touch screen, or any other means allowing a user to provide data to a processor. The processor 4302, under control of an executable procedure or executable application, manipulates the UT display images in response to signals received from the input devices. In this way, the user interacts with the display image using the input devices, enabling user interaction with the processor 4302 or another device. The functions and process steps herein may be performed automatically or wholly or partially in response to user command. An activity (including a step) performed automatically is performed in response to executable instructions or device operation without user direct initiation of the activity. An object or data object comprises a grouping of data, executable instructions, or a combination of both, or an executable procedure.

The embodiments and examples set forth herein are presented to best explain the present disclosure and its practical application and to thereby enable those skilled in the art to make and utilize the present disclosure. However, those skilled in the art will recognize that the foregoing description and examples have been presented for the purpose of illustration and example only. Thus, while preferred embodiments of the present disclosure have been described, it is to be understood that the embodiments described are illustrative only and that the scope of the invention is to be defined solely by the appended claims when accorded a full range of equivalence, many variations and modifications naturally occurring to those of skill in the art from a perusal hereof.

1. An information sharing system comprising:
a computer database storing:
user data associated with a supervisor and a subordinate, and
static data to be shared by the supervisor and the subordinate, the static data associated with a topic for training;
an application module configured to communicate with the database;
a supervisor module configured to enable the supervisor to communicate with the application module and a subordinate module; and
the subordinate module configured to:
enable the subordinate to communicate with the supervisor;
enable the subordinate to communicate with the application module via handwritten input, audio input, video input, and image input,
provide an electronic prompt to the subordinate wherein the electronic prompt is triggered by the static data, and
receive an electronic input comprising at least one of handwritten input, audio input, video input, and image input from the subordinate responsive to the prompt.

2. The information sharing system of claim 1, wherein the supervisor and the subordinate are a teacher and a student, respectively, in a virtual classroom environment, the electronic prompt is associated with a problem assigned by the teacher, the static data is associated with a curriculum plan and includes the problem, and the electronic input is a response by the student to the problem.

3. The information sharing system of claim 1, wherein the electronic input comprises handwritten input.

4. The information sharing system of claim 3, wherein the supervisor module is configured to present the response to the teacher for marking and to receive an electronic input from the teacher to provide the marked response, and the subordinate module is configured to display the marked response to the student in electronic format.

5. (canceled)

6. The information sharing system of claim 3, wherein the handwritten input comprises a plurality of handwritten segments, and the subordinate module is configured to track a time associated with production of each handwritten segment by the student.

7. The information sharing system of claim 6, wherein the subordinate module is further configured to determine a duration between provision of the electronic prompt to the student and a start time of an initial handwritten segment among the plurality of handwritten segments.

8-11. (canceled)

12. The information sharing system of claim 6, wherein the information sharing system is configured to track performance of the student based on the tracked time of each handwritten segment.

13-15. (canceled)

16. The information sharing system of claim 12, wherein the information sharing system is configured to track the performance of the student relative to at least one other student.

17. The information sharing system of claim 3, wherein the supervisor module is configured to display the handwritten input of the student to the teacher in real-time as the student produces the handwritten input.

18. (canceled)

19. The information sharing system of claim 3, wherein the student is among a plurality of students each producing handwritten input, and the supervisor module is configured to display the handwritten input of each student in the plurality of students to the teacher in real-time as each student produces handwritten input.

20-27. (canceled)

28. The information sharing system of claim 2, wherein the application module is further configured to:
create a parametric question comprising a plurality of parameters;
assign plural valid values to at least one of said plural parameters;
for said at least one parameter, automatically insert one of the valid values;
store an instantiated question in a database, the instantiated question including said one inserted valid value; and
render a worksheet in a plurality of different forms, the worksheet including said instantiated question; and
wherein the subordinate module is further configured to present the rendered worksheet in one of the forms to the student.

29-39. (canceled)

40. The information sharing system of claim 1, wherein the electronic input comprises audio input.

41. The information sharing system of claim 40, wherein the subordinate module is further configured to transmit the audio input of the subordinate to the supervisor, the supervisor module is configured to receive an audio input from the supervisor and to transmit the supervisor's audio input to the subordinate module, and the subordinate module is further configured to output the supervisor's audio input to the subordinate.

42. The information sharing system of claim 1, wherein the electronic input comprises video input.

43-44. (canceled)

45. A collaboration system comprising:
a first user module configured to display a virtual whiteboard comprising multiple layers of content to a first user among a plurality of users, each layer being associated with at least one of the plural users, wherein said first user is able to modify content only in said layer associated with said first user;
a second user module configured to display the virtual whiteboard to a second user among the plurality of users; and
a sharing module configured to connect the first and second user modules over a network for real-time collaboration between the first and second users, responsive to a request by one of the first and second users, via the virtual whiteboard,
wherein the virtual whiteboard is at least initially oriented around a contextual topic determined by the first or second user that provides a subject for the collaboration.

46. The collaboration system of claim 45, further comprising:
a computer database, and
an application module connected to the first and second user modules and to the database, the application module configured to store content of the virtual whiteboard modified by the first user in the database.

47. The collaboration system of claim 45, wherein the first and second users are a student and a teacher, respectively, in a virtual classroom environment, and the contextual topic is a question or a worksheet being tested in the virtual classroom environment.

48-49. (canceled)

50. The collaboration system of claim 45, wherein the first and second users are first and second students, respectively, in a virtual classroom environment, and the contextual topic is a question or a worksheet being tested in the virtual classroom environment.

51. The collaboration system of claim 45, wherein each user module is configured to upload to the virtual whiteboard external content selected by a corresponding user.

52. The collaboration system of claim 51, wherein said external content includes image data.

53. The collaboration system of claim 51, wherein said external content includes a link to data stored outside the collaboration system.

54. The collaboration system of claim 45, wherein each layer is associated with exactly one user.

55. (canceled)

56. The collaboration system of claim 45, wherein at least one user is associated with multiple layers.

57. The collaboration system of claim 45, wherein at least one of the user modules is configured to provide to a corresponding user an indication of at least one other user currently available for real-time collaboration via the virtual whiteboard.

58. A method for virtual collaboration, the method comprising:
receiving an electronic input from a first user;
storing the electronic input at a first layer of information;
providing the information at the first layer to a second user, wherein the second user is prevented from modifying the information at the first layer;
receiving an electronic input from the second user;
storing the second user's input at a second layer of information; and
providing the information at the second layer to the first user, wherein the first user is prevented from modifying the information at the second layer;
wherein the inputs from the first user and the second user are each selected from the group consisting of an electronic document, an image, an electronic handwritten annotation, a typed annotation, an audio annotation, a video annotation, and a link to a web page.

59. The method of claim 58, wherein the information at the first and second layers are provided asynchronously to the second and first users, respectively.

60. The method of claim 58, wherein the information at the first and second layers are provided synchronously to the second and first users, respectively, to enable real-time virtual collaboration between the first and second users.

61. The method of claim 58, further including:
providing to the first user a base layer of information comprising electronic content selected from the group consisting of an electronic textbook, an image, and an electronic document prior to receiving the electronic input from the first user;
wherein the first layer overlies the base layer, the second layer overlies the first layer, and providing information at a particular layer among the first and second layers to a particular user among the first and second users includes providing information at the particular layer and at all layers below the particular layer to the particular user.

62-64. (canceled)

65. The method of claim 61, wherein the base layer of information is associated with a continuing education curriculum for professionals, and the first user is a professional selected from the group consisting of doctors, lawyers, and accountants.

66-69. (canceled)
